(19) United States
(12) Patent Application Publication
(10) Pub. No.: US 2026/0336541 A1
(43) Pub. Date: Oct. 29, 2026

(54) IN-VEHICLE CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Keisuke WAKAZONO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/099,139

(22) PCT Filed: Jul. 29, 2022
(86) PCT No.: PCT/JP2022/029319

§ 371 Date: Jan. 28, 2025

(51) Int. Cl. B60R 16/023; B60R 16/03; H02J 1/08; H02J 1/082

(52) U.S. Cl. CPC B60R 16/0232; B60R 16/03; H02J 1/082; H02J 1/086

(57) ABSTRACT

An in-vehicle control device includes: a control unit, a voltage conversion unit, a first element part, a second element part, and a third element part. The first element part is capable of allowing a current to flow from a voltage conversion unit side to a second power path side and interrupting a current flow from the second power path side to the voltage conversion unit side. The second element part is capable of allowing a current to flow from a first power path side to a voltage conversion unit side and interrupting a current flow from the voltage conversion unit side to the first power path side. The third element part is capable of allowing a current to flow from a power storage unit side to a second power path side and interrupting a current flow from the second power path side to the power storage unit side.

### CROSS-REFERENCE TO RELATED APPLICATIONS

This application is the U.S. national stage of PCT/JP2022/029319 filed on Jul. 29, 2022, the contents of which are incorporated herein.

### TECHNICAL FIELD

The present disclosure relates to an in-vehicle control device.

### BACKGROUND

JP2020-182318A discloses a power supply system. The power supply system of JP2020-182318A includes a main battery and a secondary battery, and operates to switch the power supply source to a load from the main battery to the secondary battery when power supply from the main battery is interrupted. In the power supply system of JP2020-182318A, a switch between the secondary battery and the load includes a body diode, and when power from the main battery is interrupted, power is supplied to the load via the body diode even when this switch is OFF, so that power supply is not interrupted.

The power supply system of JP2020-182318A has a risk that if the output voltage of the secondary battery drops, no proper voltage can be supplied to the load. In order to solve this concern, it is desirable to employ a discharge circuit that can supply a proper voltage to the load based on power from the secondary battery. However, simply employing such a discharge circuit would complicate the device configuration. On the other hand, in a system that can supply power to a load from a secondary battery, if the secondary battery is discharged for some reason, the secondary battery needs to be recharged in case of failure, and it is thus desirable to employ a charging circuit that can supply a proper voltage to the secondary battery. However, simply employing such a charging circuit would cause further complications.

The present disclosure relates to an in-vehicle control device capable of a backup operation for supplying power based on a power storage unit, and an object thereof is to provide a technology that can adjust a charging voltage when charging the power storage unit and a discharging voltage when discharging the power storage unit with a simpler configuration, and can discharge the power storage unit via a path different from the path in which the voltages are adjusted.

### SUMMARY

According to one mode of the present disclosure, provided is an in-vehicle control device for use in an in-vehicle system provided with: a power source unit for supplying power; a power storage unit that is not the power source unit; a first power path to which a voltage based on the power source unit is applied; a second power path serving as a path for supplying power supplied from the first power path to a load; a third power path that is not the first power path and the second power path; and a fourth power path to which a voltage based on the power storage unit is applied, the in-vehicle control device being configured to control power supply from the power storage unit and including: a voltage conversion unit configured to perform a first conversion operation of converting a voltage applied to the third power path and applying an output voltage to the fourth power path, and a second conversion operation of converting a voltage applied to the fourth power path and applying an output voltage to the third power path; a control unit configured to control the voltage conversion unit; a first element part capable of allowing a current to flow from a voltage conversion unit side to a second power path side and interrupting a current flow from the second power path side to the voltage conversion unit side; a second element part capable of allowing a current to flow from a first power path side to a voltage conversion unit side and interrupting a current flow from the voltage conversion unit side to the first power path side; and a third element part capable of allowing a current to flow from a power storage unit side to a second power path side and interrupting a current flow from the second power path side to the power storage unit side.

### ADVANTAGEOUS EFFECTS

The technology according to the present disclosure can adjust a charging voltage when charging a power storage unit and a discharging voltage when discharging the power storage unit with a simpler configuration, and can discharge the power storage unit via a path different from the path in which voltages are adjusted.

### BRIEF DESCRIPTION OF DRAWINGS

FIG. 1 is a circuit diagram schematically showing an example of an in-vehicle system including an in-vehicle control device of a first embodiment.

FIG. 2 is a flowchart exemplifying a flow of backup control executed by the in-vehicle control device of the first embodiment.

FIG. 3 is an illustrative diagram illustrating an example of power supply operation executed by the in-vehicle control device of the first embodiment when a first power path is in a normal state.

FIG. 4 is an illustrative diagram illustrating example of changes over time in voltage (power source voltage) of the first power path, operation of a voltage conversion unit, and voltage (power storage unit voltage) of a fourth power path, when the first power path is in a normal state.

FIG. 5 is an illustrative diagram illustrating an example of power supply operation executed by the in-vehicle control device of the first embodiment when the first power path has a value not greater than a first threshold and no failure determination condition is satisfied.

FIG. 6 is an illustrative diagram illustrating examples of changes over time in voltage of the first power path and voltage (load voltage) of a second power path, current in third and fourth element parts, operation of the voltage conversion unit, and voltage of the fourth power path, when the first power path has a value not greater than the first threshold and no failure determination condition is satisfied.

FIG. 7 is an illustrative diagram illustrating an example of power supply operation executed by the in-vehicle control device of the first embodiment when the first power path has a value not greater than the first threshold and immediately after a failure determination condition is satisfied.

FIG. 8 is an illustrative diagram illustrating an example of power supply operation executed by the in-vehicle control device of the first embodiment after a certain amount of time has elapsed since the failure determination condition was satisfied.

FIG. 9 is an illustrative diagram illustrating examples of changes over time in voltage of the first and second power paths, current in the first and third element parts, and operation of the voltage conversion unit, when the first power path has a value not greater than the first threshold and a failure determination condition is satisfied.

FIG. 10 is an illustrative diagram illustrating an example of power supply operation executed by the in-vehicle control device of the first embodiment when an abnormality has occurred in the fourth element part while the first power path is in a normal state.

FIG. 11 is an illustrative diagram illustrating examples of changes over time in voltage of the first power path, and current in the first and fourth element parts, when an abnormality has occurred in the fourth element part while the first power path is in a normal state.

FIG. 12 is an illustrative diagram illustrating an example of power supply operation executed by the in-vehicle control device of the first embodiment when the first power path has a value not smaller than an overvoltage threshold.

FIG. 13 is an illustrative diagram illustrating examples of changes over time in voltage of the first power path, current in the third and fourth element parts, operation of the voltage conversion unit, and voltage of the fourth power path, when the first power path has a value not smaller than the overvoltage threshold.

FIG. 14 is a circuit diagram schematically showing an example of an in-vehicle system including an in-vehicle control device of a second embodiment.

FIG. 15 is an illustrative diagram illustrating an example of power supply operation executed by the in-vehicle control device of the second embodiment when a first power path is in a normal state.

FIG. 16 is an illustrative diagram illustrating an example of power supply operation executed by the in-vehicle control device of the second embodiment when a second power path has a value not greater than the first threshold and no failure determination condition is satisfied.

FIG. 17 is an illustrative diagram illustrating an example of power supply operation executed by the in-vehicle control device of the second embodiment when the first power path has a value not greater than the first threshold and immediately after the failure determination condition is satisfied.

FIG. 18 is an illustrative diagram illustrating an example of power supply operation executed by the in-vehicle control device of the second embodiment after a certain amount of time has elapsed since the failure determination condition has satisfied.

FIG. 19 is an illustrative diagram illustrating an example of power supply operation executed by the in-vehicle control device of the second embodiment when the first power path has a value not smaller than the overvoltage threshold.

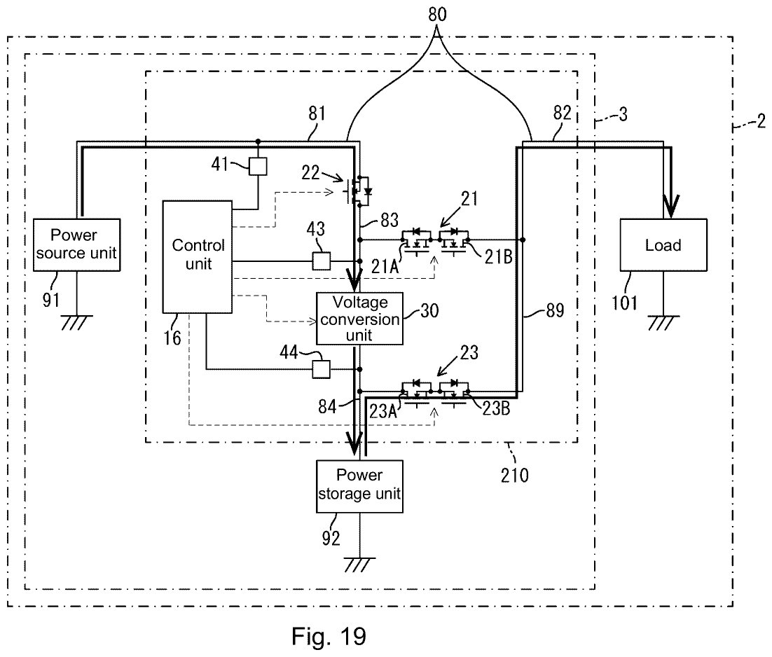

FIG. 20 is a circuit diagram schematically showing an example of an in-vehicle system including an in-vehicle control device of a third embodiment.

FIG. 21 is an illustrative diagram showing modifications of element parts.

### DETAILED DESCRIPTION OF PREFERRED EMBODIMENTS

Hereinafter, embodiments of the present disclosure are listed and exemplified. Note that the features exemplified in the following description may be combined in any combination as long as they do not contradict each other.

In a first aspect, provided is an in-vehicle control device for use in an in-vehicle system provided with: a power source unit for supplying power; a power storage unit that is not the power source unit; a first power path to which a voltage based on the power source unit is applied; a second power path serving as a path for supplying power supplied from the first power path to a load; a third power path that is not the first power path and the second power path; and a fourth power path to which a voltage based on the power storage unit is applied, the in-vehicle control device being configured to control power supply from the power storage unit and including: a voltage conversion unit configured to perform a first conversion operation of converting a voltage applied to the third power path and applying an output voltage to the fourth power path, and a second conversion operation of converting a voltage applied to the fourth power path and applying an output voltage to the third power path; a control unit configured to control the voltage conversion unit; a first element part capable of allowing a current to flow from a voltage conversion unit side to a second power path side and interrupting a current flow from the second power path side to the voltage conversion unit side; a second element part capable of allowing a current to flow from a first power path side to a voltage conversion unit side and interrupting a current flow from the voltage conversion unit side to the first power path side; and a third element part capable of allowing a current to flow from a power storage unit side to a second power path side and interrupting a current flow from the second power path side to the power storage unit side.

The in-vehicle control device according to the first aspect can charge the power storage unit while applying a desired voltage to the fourth power path, by causing the voltage conversion unit to perform the first conversion operation with the second element part allowing a current to flow from the first power path side to the voltage conversion unit side. On the other hand, this in-vehicle control device can supply power to the second power path while applying a desired voltage to the third power path, by causing the voltage conversion unit to perform the second conversion operation with the first element part allowing a current to flow from the voltage conversion unit side to the second power path side. In other words, the in-vehicle control device can adjust a charging voltage when charging the power storage unit and a discharging voltage when discharging the power storage unit with a simpler configuration, and in some cases, the second element part can interrupt a current flow from the voltage conversion unit side to the first power path side. Furthermore, since the third element part is provided and can allow a current to flow from the power storage unit side to the second power path side, the power storage unit can be discharged through a path different from the path in which the voltage is adjusted by the voltage conversion unit. Furthermore, since the third element part is capable of interrupting a current flow from the second power path side to the power storage unit side, in some cases, the third element part can interrupt a current flow into the power storage unit from the second power path side to through the third element part.

In a second aspect, the in-vehicle control device according to the first aspect further includes a fourth element part capable of allowing a current to flow from a first power path side to a second power path side and interrupting a current flow from the second power path side to the first power path side.

In the in-vehicle control device according to the second aspect, since the fourth element part can allow a current to flow from the first power path side to the second power path side, power based on the power source unit can be supplied directly to the second power path via the fourth element part. On the other hand, in some cases, the fourth element part can interrupt a current flow from the second power path side to the first power path side.

In a third aspect, the in-vehicle control device according to the second aspect is such that the fourth element part is configured to interrupt a current flow between the first power path and the second power path through the fourth element part in both directions when the fourth element part is OFF, and to allow a current to flow from the first power path to the second power path through the fourth element part when the fourth element part is ON, if a voltage of the first power path exceeds a first threshold, the control unit turns on the fourth element part, and if the voltage of the first power path is less than or equal to the first threshold, the control unit turns off the fourth element part with the third element part allowing a current to flow from the power storage unit side to the second power path side.

By turning on the fourth element part if the voltage of the first power path exceeds the first threshold, the in-vehicle control device according to the third aspect can directly supply power based on the power source unit to the second power path while suppressing a loss. On the other hand, if the voltage of the first power path is less than or equal to the first threshold, the control unit can turn off the fourth element part with the third element part allowing a current to flow from the power storage unit side to the second power path side, so that it is possible to keep the first power path from affecting the second power path via the fourth element part and let a discharge current flow from the power storage unit to the second power path via the third element part.

In a fourth aspect, the in-vehicle control device according to the second or the third aspect further includes an abnormality detection unit configured to detect an abnormality in the fourth element part, wherein the first element part is configured to interrupt a current flow between the third power path and the second power path through the first element part in both directions when the first element part is OFF, and to allow a current to flow from the third power path to the second power path through the first element part when the first element part is ON, and if an abnormality in the fourth element part is detected by the abnormality detection unit, the control unit turns on the first element part with the second element part allowing a current to flow from the first power path side to the third power path side.

In the in-vehicle control device according to the fourth aspect, if an abnormality in the fourth element part is detected by the abnormality detection unit, the control unit can turn on the first element part with the second element part allowing a current to flow from the first power path side to the third power path side, so that the paths of the second element part and the first element part can be used to supply power from the first power path side to the second power path side. On the other hand, the first element part can be turned off, and in this case, a current can be prevented from flowing into the third power path side from the second power path side via the first element part.

In a fifth aspect, the in-vehicle control device according to any one of the second to the fourth aspects is such that the fourth element part is configured to interrupt a current flow between the first power path and the second power path through the fourth element part in both directions when the fourth element part is OFF, and to allow a current to flow from the first power path to the second power path through the fourth element part when the fourth element part is ON, if a voltage of the first power path exceeds a first threshold and is less than a voltage threshold, which is greater than the first threshold, the control unit turns on the fourth element part, and if the voltage of the first power path is greater than or equal to the voltage threshold, the control unit turns off the fourth element part with the third element part allowing a current to flow from the power storage unit side to the second power path side.

By turning on the fourth element part if the voltage of the first power path is large enough to exceed the first threshold but is not large enough to reach the above-mentioned voltage threshold, the in-vehicle control device according to the fifth aspect can directly supply power based on the power source unit to the second power path while suppressing a loss. On the other hand, if the voltage of the first power path increases too high to the extent that it is greater than or equal to the above-mentioned voltage threshold, the in-vehicle control device can turn off the fourth element part with the third element part allowing a current to flow from the power storage unit side to the second power path side, so that it is possible to keep the overvoltage of the first power path from affecting the second power path via the fourth element part and let a discharge current flow from the power storage unit to the second power path via the third element part.

In a sixth aspect, the in-vehicle control device according to the fifth aspect is such that if the voltage of the first power path is greater than or equal to the voltage threshold, the control unit causes the voltage conversion unit to perform the first conversion operation with the third element part allowing a current to flow from the power storage unit side to the second power path side.

If the voltage of the first power path increases too high to the extent that it is greater than or equal to the above-mentioned voltage threshold, the in-vehicle control device according to the sixth aspect can let a discharge current flow to the second power path via the third element part while supplying power from the voltage conversion unit to the power storage unit using power from the first power path.

In a seventh aspect, the in-vehicle control device according to any one of the first to the third aspects is such that the second element part is configured to interrupt a current flow between the first power path and the third power path through the second element part in both directions when the second element part is OFF, and to allow a current to flow from the first power path to the third power path through the second element part when the second element part is ON, if a voltage of the first power path exceeds a first threshold and is less than a voltage threshold, which is greater than the first threshold, the control unit turns on the second element part, and if the voltage of the first power path is greater than or equal to the voltage threshold, the control unit turns off the second element part and causes the voltage conversion unit to perform the second conversion operation with the first element part allowing a current to flow from the third power path side to the second power path side.

If the voltage of the first power path exceeds the first threshold and is less than the voltage threshold, the in-vehicle control device according to the seventh aspect can turn on the second element part to allow power supply from the first power path side to the voltage conversion unit side. On the other hand, if the voltage of the first power path increases too high to a value greater than or equal to the above-mentioned voltage threshold, the voltage conversion unit can perform the second conversion operation while the second element part is turned off to interrupt a current flow from the first power path side to the third power path side and to allow a current to flow from the third power path side to the second power path side via the first element part.

In an eighth aspect, the in-vehicle control device according to any one of the first to the seventh aspects is such that if a predetermined condition is satisfied when a voltage of the first power path is less than or equal to a first threshold, the control unit causes the voltage conversion unit to perform the first conversion operation with the third element part allowing a current to flow from the power storage unit side to the second power path side.

If the predetermined condition is satisfied even when the voltage of the first power path drops to a value less than or equal to the first threshold, the in-vehicle control device according to the eighth aspect can cause the voltage conversion unit to perform the first conversion operation to supply power to the power storage unit side, and can also supply power to the second power path side via the third element part while supplying power to the power storage unit side.

In a ninth aspect, the in-vehicle control device according to the eighth aspect is such that the predetermined condition includes a condition that a predetermined failure determination condition is not satisfied, if the failure determination condition is not satisfied when the voltage of the first power path is less than or equal to the first threshold, the control unit causes the voltage conversion unit to perform the first conversion operation with the second element part allowing a current to flow from the first power path side to the voltage conversion unit side, and if the failure determination condition is satisfied when the voltage of the first power path is less than or equal to the first threshold, the control unit causes the voltage conversion unit to perform the second conversion operation, with the second element part interrupting a current flow from the voltage conversion unit side to the first power path side and the first element part allowing a current to flow from the third power path side to the second power path side.

If the failure determination condition is not satisfied even when the voltage of the first power path drops to a value less than or equal to the first threshold, the in-vehicle control device according to the ninth aspect can cause the voltage conversion unit to perform the first conversion operation with the second element part allowing a current to flow to the voltage conversion unit side, and can charge the power storage unit. On the other hand, if the failure determination condition is satisfied, this in-vehicle control device can supply the voltage adjusted based on the voltage conversion operation of the voltage conversion unit to the second power path while interrupting a reverse flow to the first power path side.

In a tenth aspect, the in-vehicle control device according to the ninth aspect is such that the third element part is configured to interrupt a current flow between the fourth power path and the second power path through the third element part in both directions when the third element part is OFF, and to allow a current to flow from the fourth power path to the second power path through the third element part when the third element part is ON, the control unit controls ON/OFF of at least the third element part, and if the voltage of the first power path is less than or equal to the first threshold and switching is made from a state where the failure determination condition is not satisfied to a state where the failure determination condition is satisfied, the control unit keeps the third element part ON before and after the switching, the control unit causes, after the switching, the voltage conversion unit to perform the second conversion operation with the second element part interrupting a current flow from the voltage conversion unit side to the first power path side and the first element part allowing a current to flow from the third power path side to the second power path side, and the control unit switches off the third element part if the voltage conversion unit satisfies a predetermined operation condition after the switching.

If the voltage of the first power path is less than or equal to the first threshold and the state is changed to a state in which the failure determination condition is not satisfied, the in-vehicle control device according to the tenth aspect can turn on the third element part to quickly supply power to the second power path from the power storage unit. If the state is switched from the state in which the failure determination condition is not satisfied to the state in which the failure determination condition is satisfied when the voltage of the first power path is less than or equal to the first threshold, it is possible, after the switching, to supply power whose voltage is adjusted by the second conversion operation to the second power path via the third power path and the first element part, while preventing a reverse flow to the first power path side. Moreover, since this in-vehicle control device can keep the third element part ON before and after the switching, it is possible to maintain power supply from the power storage unit to the second power path via the third element part even if the output of the voltage conversion unit rises slowly after the above-mentioned switching. Furthermore, if the voltage conversion unit satisfies a predetermined operation condition after the switching, this in-vehicle control device can switch off the third element part to narrow down the discharge path, from among the paths of the first element part and the third element part, to the path of the first element part.

In an eleventh aspect, the in-vehicle control device according to the ninth or the tenth aspect is such that the failure determination condition includes a condition that a current flows from the voltage conversion unit side to the first power path side via the second element part, if no current flows from the voltage conversion unit side to the first power path side via the second element part when the voltage of the first power path is less than or equal to the first threshold, the control unit causes the voltage conversion unit to perform the first conversion operation with the second element part allowing a current to flow from the first power path side to the voltage conversion unit side, and the third element part allows a current to flow from the power storage unit side to the second power path side, and if a current flows from the voltage conversion unit side to the first power path side via the second element part when the voltage of the first power path is less than or equal to the first threshold, the control unit causes the voltage conversion unit to perform the second conversion operation, with the second element part interrupting a current flow from the voltage conversion unit side to the first power path side and the first element part allowing a current to flow from the third power path side to the second power path side.

If the voltage of the first power path is less than or equal to the first threshold, the in-vehicle control device according to the eleventh aspect confirms that no current flows to the first power path side via the second element part, i.e., that it is highly likely that no ground fault has occurred in the first power path, and then causes the voltage conversion unit to perform the first conversion operation to charge the power storage unit. Then, this in-vehicle control device can perform discharge of power via the third element part in parallel with supply of power to the power storage unit side due to the above-mentioned first conversion operation. On the other hand, if the voltage of the first power path is less than or equal to the first threshold and a current flows to the first power path side via the second element part, i.e., it is highly likely that a ground fault has occurred in the first power path, this in-vehicle control device can interrupt a current flow through the second element part to the first power path side and can suppress the ground fault from affecting the third power path side. Then, by causing the voltage conversion unit to perform the second conversion operation with the first element part allowing a current to flow to the second power path side, it is possible to supply power whose voltage is adjusted by the voltage conversion unit to the second power path while suppressing the effect of the ground fault.

In a twelfth aspect, the in-vehicle control device according to any one of the ninth to the eleventh aspects is such that the failure determination condition includes a condition that the voltage of the first power path is less than or equal to a second threshold, which is lower than the first threshold, if the voltage of the first power path is less than or equal to the first threshold and exceeds the second threshold, the control unit causes the voltage conversion unit to perform the first conversion operation with the second element part allowing a current to flow from the first power path side to the voltage conversion unit side, and the third element part allows a current to flow from the power storage unit side to the second power path side, and if the voltage of the first power path is less than or equal to the second threshold, the control unit causes the voltage conversion unit to perform the second conversion operation, with the second element part interrupting a current flow from the voltage conversion unit side to the first power path side and the first element part allowing a current to flow from the third power path side to the second power path side.

If the voltage of the first power path is less than or equal to the first threshold, the in-vehicle control device according to the twelfth aspect can confirm that the voltage exceeds the second threshold, i.e., that the voltage of the first power path is not too low, and then can cause the voltage conversion unit to perform the first conversion operation to charge the power storage unit. Then, the in-vehicle control device can perform discharge of power via the third element part in parallel with supply of power to the power storage unit side due to the above-mentioned first conversion operation. On the other hand, if the voltage of the first power path is less than or equal to the second threshold, i.e., the voltage of the first power path is too low, it is possible to interrupt a current flow through the second element part to the first power path side, and thus even if a ground fault has occurred in the first power path, it is possible to suppress the ground fault from affecting the third power path side. Then, by causing the voltage conversion unit to perform the second conversion operation with the first element part allowing a current to flow to the second power path side, it is possible to supply power whose voltage is adjusted by the voltage conversion unit to the second power path while suppressing the effect of the voltage drop at the first power path.

In a thirteenth aspect, the in-vehicle control device according to any one of the ninth to the twelfth aspects is such that the failure determination condition includes a condition that a predetermined failure signal is given to the in-vehicle control device from an external device other than the in-vehicle control device, if the voltage of the first power path is less than or equal to the first threshold and no failure signal is given from the external device, the control unit causes the voltage conversion unit to perform the first conversion operation with the second element part allowing a current to flow from the first power path side to the voltage conversion unit side, and the third element part allows a current to flow from the power storage unit side to the second power path side, and if the voltage of the first power path is less than or equal to the first threshold and the failure signal is given from the external device, the control unit causes the voltage conversion unit to perform the second conversion operation with the second element part interrupting a current flow from the voltage conversion unit side to the first power path side and the first element part allowing a current to flow from the third power path side to the second power path side.

If the voltage of the first power path is less than or equal to the first threshold, the in-vehicle control device according to the thirteenth aspect can confirm that no failure signal has been given from an external device, and then can cause the voltage conversion unit to perform the first conversion operation to charge the power storage unit. Then, this in-vehicle control device can perform discharge of power via the third element part in parallel with supply of power to the power storage unit side due to the above-mentioned first conversion operation. On the other hand, if a failure signal is generated when the voltage of the first power path is less than or equal to the first threshold, it is possible to cause the voltage conversion unit to perform the second conversion operation with the second element part interrupting a current flow to the first power path side and the first element part allowing a current to flow to the second power path side. Accordingly, even if a ground fault or the like occurs in the first power path when a failure signal is generated, it is possible to supply power whose voltage is adjusted by the voltage conversion unit to the second power path while suppressing the effect of the failure signal.

In a fourteenth aspect, the in-vehicle control device according to any one of the eighth to the thirteenth aspects is such that during a period in which the voltage conversion unit is caused to perform the first conversion operation with the third element part allowing a current to flow from the power storage unit side to the second power path side, the control unit sets power supplied from the voltage conversion unit to the fourth power path side to be larger than power supplied to the second power path side via the third element part.

When performing the first conversion operation and the discharge through the third element part in parallel, the in-vehicle control device according to the fourteenth aspect can set a larger charging power based on the first conversion operation relative to a discharging power via the third element part. Therefore, when the above-mentioned parallel operations are performed, it is possible to supply power to the second conductive path while ensuring a charging current to the power storage unit more reliably.

In a fifteenth aspect, the in-vehicle control device according to any one of the first to the fourteenth aspects is such that if the voltage of the first power path exceeds the first threshold and an output voltage of the power storage unit is less than or equal to a predetermined value, the control unit causes the voltage conversion unit to perform the first conversion operation with the second element part allowing a current to flow from the first power path side to the voltage conversion unit side.

If the output voltage of the power storage unit drops to a value less than or equal to a predetermined value, the in-vehicle control device according to the fifteenth aspect can charge the power storage unit through the first conversion operation.

### Summary of In-Vehicle System

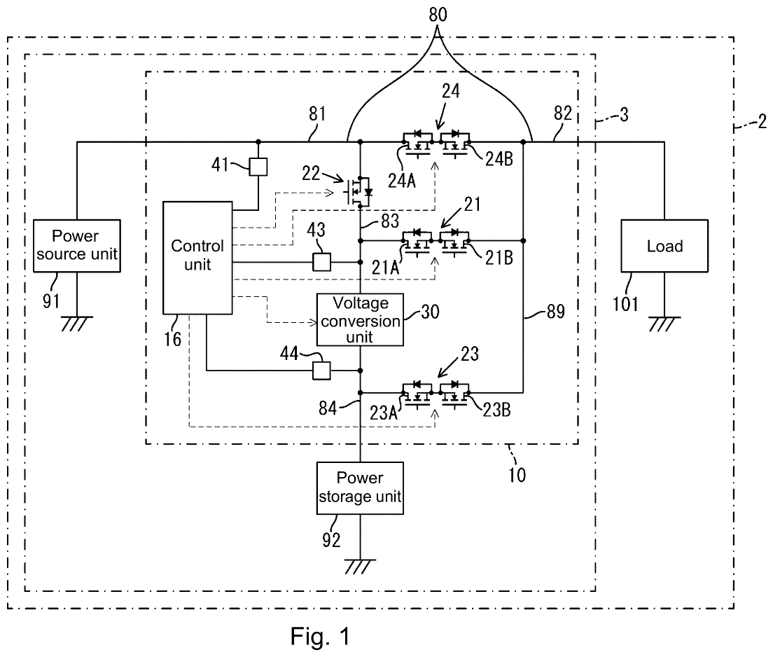

FIG. 1 shows an in-vehicle system 2. The in-vehicle system 2 shown in FIG. 1 mainly includes an in-vehicle power source system 3 and a load 101. In the following description, the in-vehicle power source system 3 is also referred to as power source system 3. The in-vehicle system 2 is a system that supplies power to the load 101 using the power source system 3, and operates the load 101. In FIG. 1, the load 101 is shown as an example of an in-vehicle load, but other loads may also be provided in the in-vehicle system 2.

The load 101 is an electrical component installed in a vehicle. The load 101 operates upon receiving power supplied via a power path 80. There is no limitation to the type of load 101. Various known in-vehicle components can be employed as the load 101. The load 101 may include a plurality of electrical components or may be a single electrical component.

The power source system 3 is a system that supplies power to the load 101. The power source system 3 uses a power source unit 91 or a power storage unit 92 as a power supply source to supply power to the load 101. The power source system 3 can supply power to the load 101 from the power source unit 91, and if the power supply from the power source unit 91 is interrupted, for example, due to a failure, the power source system 3 can supply power to the load 101 from the power storage unit 92. The power storage unit 92 may also be used as a supply source for supplying power to the load 101 when the power supply from the power source unit 91 to the load 101 is not interrupted, depending on the circumstances.

### Overview of Power Source System

The power source system 3 includes the power source unit 91, the power storage unit 92, and an in-vehicle control device 10, for example. Note that in the representative example shown in FIG. 1, a first power path 81, a second power path 82, a third power path 83, a fourth power path 84, a conductive path 89, and the like are included as constituent components of the in-vehicle control device 10. However, part or whole of each of the first power path 81, the second power path 82, the third power path 83, the fourth power path 84, and the conductive path 89 need not be elements of the in-vehicle control device 10.

The power source unit 91 is an in-vehicle power supply that can supply power to the load 101. The power source unit 91 is configured as a known in-vehicle power storage unit such as a lead battery, for example. The power source unit 91 may also be configured by a battery (such as e.g., a lithium-ion battery and another battery) other than a lead battery, and may include, instead of or in addition to a battery, a power supply means other than the battery. In the example of FIG. 1, the positive terminal of the power source unit 91 is electrically connected to the first power path 81, which is a part of the power path 80, in a configuration in which it is shorted to the first power path 81. The negative terminal of the power source unit 91 is electrically connected to the ground in a configuration in which it is shorted to the ground. The power source unit 91 applies a DC voltage of a constant value to the first power path 81. The voltage applied to the first power path 81 by the power source unit 91 may vary slightly from the above-mentioned constant value.

The power storage unit 92 is a power source other than the power source unit 91. The power storage unit 92 is a power source that serves as a power supply source at least when the power supply from the power source unit 91 is interrupted. The power storage unit 92 is constituted by a known power storage means such as an electric double layer capacitor (EDLC), for example. The power storage unit 92 may also be constituted by a capacitor other than an electric double layer capacitor, and may also include, instead of or in addition to a capacitor, another storage means (such as a battery). In the example of FIG. 1, the positive terminal of the power storage unit 92 is electrically connected to the fourth power path 84 in a configuration in which it is shorted to the fourth power path 84. The negative terminal of the power storage unit 92 is electrically connected to the ground in a configuration in which it is shorted to the ground. The output voltage of the power storage unit 92 (voltage applied to the fourth power path 84 by the power storage unit 92) may be greater than, less than, or equal to the output voltage of the power source unit 91 (voltage applied to the first power path 81 by the power source unit 91).

In the present specification, “voltage” refers to a voltage relative to the ground potential (e.g., 0 V) and is the potential difference from the ground potential, unless otherwise specified. For example, the voltage applied to the first power path 81 is the potential difference between the potential of the first power path 81 and the ground potential. The voltage applied to the fourth power path 84 is the potential difference between the potential of the fourth power path 84 and the ground potential.

The power path 80 is a path through which power based on the power source unit 91 is transmitted, and is a path through which power based on the power source unit 91 is supplied to the load 101. In the example in FIG. 1, the power path 80 includes the first power path 81 to which a voltage based on the power source unit 91 is applied, and the second power path 82 that serves as a path for supplying power supplied from the first power path 81 to the load 101.

The first power path 81 is a conductive path that constitutes part or whole of the power supply path between the power source unit 91 and a second element part 22. The same or substantially the same voltage as the output voltage of the power source unit 91 is applied to the first power path 81. A portion of the first power path 81 on one end side is electrically connected to the positive terminal of the power source unit 91 in a configuration in which it is shorted to that positive terminal. In the example in FIG. 1, a portion of the first power path 81 on the other end side is electrically connected to one end of the second element part 22 (in the example in FIG. 1, the drain terminal, which is one end of a semiconductor switch) in a configuration in which it is shorted to that one end. Furthermore, a portion of the first power path 81 is electrically connected to one end of a fourth element part 24 (in the example in FIG. 1, the drain terminal, which is one end of a semiconductor switch 24A) in a configuration in which it is shorted to that one end. The first power path 81 may be provided with a relay or a fuse. The first power path 81 functions to make the potentials at the positive terminal of the power source unit 91, one end of the second element part 22, and one end of the fourth element part 24 equal or substantially equal to each other, for example.

The second power path 82 is a conductive path that constitutes part or whole of the power supply path between a first element part 21 and the load 101. A portion of the second power path 82 on one end side is electrically connected to the other end of the first element part 21 (in the example in FIG. 1, the drain terminal, which is the other end of a semiconductor switch 21B). Furthermore, a portion of the second power path 82 is electrically connected to the other end of the fourth element part 24 (in the example in FIG. 1, the drain terminal, which is one end of a semiconductor switch 24B) in a configuration in which it is shorted to that other end, and is electrically connected to the other end of a third element part 23 (in the example in FIG. 1, the drain terminal, which is one end of a semiconductor switch 23B) in a configuration in which it is shorted to that other end. In the example in FIG. 1, a portion of the second power path 82 on the other end side is electrically connected to one end of the load 101 in a configuration in which it is shorted to the one end of the load 101. The second power path 82 may be provided with a relay or a fuse. The second power path 82 functions to make the potentials at the other end of the first element part 21, the other end of the fourth element part 24, and the other end of the third element part 23, and one end of the load 101 equal or substantially equal to each other, for example.

The third power path 83 is a power path that is not the first power path 81 and the second power path 82. A portion of the third power path 83 on one end side is electrically connected to the other end of the second element part 22 (in the example in FIG. 1, the source terminal, which is the other end of the semiconductor switch) in a configuration in which it is shorted to that other end. A portion of the other end of the third power path 83 is electrically connected to one end of the voltage conversion unit 30 in a configuration in which it is shorted to that one end. A portion of the third power path 83 is electrically connected to one end of the first element part 21 (in the example in FIG. 1, the drain terminal, which is one end of a semiconductor switch 21A) in a configuration in which it is shorted to that one end. The third power path 83 functions to make the potentials at one end of the first element part 21, the other end of the second element part 22, and one end of a voltage conversion unit 30 equal or substantially equal to each other, for example.

The fourth power path 84 is a power path that is not the first power path 81, the second power path 82, and the third power path 83, and is a power path to which a voltage based on the power storage unit 92 is applied. A portion of the fourth power path 84 on one end side is electrically connected to the other end of the voltage conversion unit 30 in a configuration in which it is shorted to that other end. A portion of the fourth power path 84 on the other end side is electrically connected to the positive terminal of the power storage unit 92 in a configuration in which it is shorted to that positive terminal. A portion of the fourth power path 84 is electrically connected to one end of the third element part 23 (in the example in FIG. 1, the drain terminal, which is one end of a semiconductor switch 23A) in a configuration in which it is shorted to that one end. The fourth power path 84 functions to make the potentials at the other end of the voltage conversion unit 30, the positive terminal of the power storage unit 92, and one end of the third element part 23 equal or substantially equal to each other, for example.

### Detail of In-vehicle Control Device

The in-vehicle control device 10 is a device that is used in the in-vehicle system 2 and controls power supply from the power storage unit 92. The in-vehicle control device 10 is a backup control device that can control a backup operation for outputting power based on the power storage unit 92. The in-vehicle control device 10 includes the first power path 81, the second power path 82, the third power path 83, the fourth power path 84, a control unit 16, the voltage conversion unit 30, the first element part 21, the second element part 22, the third element part 23, the fourth element part 24, voltage detection units 41, 43, and 44, and the like.

Although, in the representative examples, the in-vehicle control device 10 includes the first power path 81, the second power path 82, the third power path 83, and the fourth power path 84, the in-vehicle control device 10 may include only some of the first power path 81, the second power path 82, the third power path 83, and the fourth power path 84, and some or all of these power paths need not be elements of the in-vehicle control device 10.

In the representative example in FIG. 1, the first element part 21 is constituted by two semiconductor switches 21A and 21B. The second element part 22 is constituted by one semiconductor switch. The third element part 23 is constituted by two semiconductor switches 23A and 23B. The fourth element part 24 is constituted by two semiconductor switches 24A and 24B. In the example in FIG. 1, the semiconductor switches 21A, 21B, 22, 23A, 23B, 24A, and 24B are each composed of an N-channel Field Effect Transistor (FET).

The first element part 21 is a switch part capable of allowing a current to flow from the voltage conversion unit 30 side to the second power path 82 side and capable of interrupting a current flow from the second power path 82 side to the voltage conversion unit 30 side. The semiconductor switches 21A and 21B constituting the first element part 21 are connected to each other in opposite orientations. In the example in FIG. 1, the drain of the semiconductor switch 21A is shorted to the third power path 83, the drain of the semiconductor switch 21B is shorted to the second power path 82, and the source of the semiconductor switch 21A and the source of semiconductor switch 21B are shorted to each other. A state where the first element part 21 is OFF means that both the semiconductor switches 21A and 21B are OFF. When the first element part 21 is OFF, a current flow through the first element part 21 is interrupted in both directions, namely, both a current flow from the second power path 82 side to the voltage conversion unit 30 side and a current flow from the voltage conversion unit 30 side to the second power path 82 side are interrupted. A state where the first element part 21 is ON means that both the semiconductor switches 21A and 21B are ON. When the first element part 21 is ON, a current is allowed to flow through the first element part 21 in both directions, namely, both a current flow from the second power path 82 side to the voltage conversion unit 30 side and a current flow from the voltage conversion unit 30 side to the second power path 82 side are allowed.

The second element part 22 is configured to allow a current to flow from the first power path 81 side to the voltage conversion unit 30 side and to interrupt a current flow from the voltage conversion unit 30 side to the first power path 81 side. In the example of FIG. 1, the drain of the second element part 22 is electrically connected to the third power path 83 so as to be shorted thereto, and the source of the second element part 22 is electrically connected to the first power path 81 so as to be shorted thereto. When the second element part 22 is ON, a current is allowed to flow through the second element part 22 in both directions. When the second element part 22 is OFF, a current flow from the voltage conversion unit 30 side to the first power path 81 side via the second element part 22 is always interrupted.

The third element part 23 is a switch part capable of allowing a current to flow from the power storage unit 92 side to the second power path 82 side and capable of interrupting a current flow from the second power path 82 side to the power storage unit 92 side. The semiconductor switches 23A and 23B constituting the third element part 23 are connected to each other in opposite orientations. In the example in FIG. 1, the drain of the semiconductor switch 23A is shorted to the fourth power path 84, the drain of the semiconductor switch 23B is shorted to the second power path 82, and the source of the semiconductor switch 24A and the source of semiconductor switch 24B are shorted to each other. A state where the third element part 23 is OFF means that both the semiconductor switches 23A and 23B are OFF. When the third element part 23 is OFF, a current flow through the third element part 23 is interrupted in both directions, namely, both a current flow from the second power path 82 side to the power storage unit 92 side via the third element part 23 and a current flow from the power storage unit 92 side to the second power path 82 side via the third element part 23 are interrupted. A state where the third element part 23 is ON means that both the semiconductor switches 23A and 23B are ON. When the third element part 23 is ON, a current is allowed to flow through the third element part 23 in both directions, namely, both a current flow from the second power path 82 side to the power storage unit 92 side and a current flow from the power storage unit 92 side to the second power path 82 side are allowed.

The fourth element part 24 is a switch part capable of allowing a current to flow from the first power path 81 side to the second power path 82 side and capable of interrupting a current flow from the second power path 82 side to the first power path 81 side. The semiconductor switches 24A and 24B constituting the fourth element part 24 are connected to each other in opposite orientations. In the example in FIG. 1, the drain of the semiconductor switch 24A is shorted to the first power path 81, the drain of the semiconductor switch 24B is shorted to the second power path 82, and the source of the semiconductor switch 24A and the source of semiconductor switch 24B are shorted to each other. A state where the fourth element part 24 is OFF means that both the semiconductor switches 24A and 24B are OFF. When the fourth element part 24 is OFF, a current flow through the fourth element part 24 is interrupted in both directions, namely, both a current flow from the first power path 81 side to the second power path 82 side via the fourth element part 24 and a current flow from the second power path 82 side to the first power path 81 side via the fourth element part 24 are interrupted. A state where the fourth element part 24 is ON means that both the semiconductor switches 24A and 24B are ON. When the fourth element part 24 is ON, a current is allowed to flow through the fourth element part 24 in both directions, namely, both a current flow from the first power path 81 side to the second power path 82 side and a current flow from the second power path 82 side to the first power path 81 side are allowed.

The voltage conversion unit 30 is constituted by a known voltage conversion circuit such as a DCDC converter, for example. In the example in FIG. 1, the voltage conversion unit 30 performs voltage conversion between the third power path 83 and the fourth power path 84. The voltage conversion unit 30 is a device that performs a first conversion operation of converting a voltage applied to the third power path 83 so as to step up or down the voltage and applying the output voltage to the fourth power path 84, and a second conversion operation of converting a voltage applied to the fourth power path 84 so as to step up or down the voltage and applying the output voltage to the third power path 83. Thus, the voltage conversion unit 30 performs voltage conversion in both directions. The operation of the voltage conversion unit 30 is controlled by the control unit 16.

The control unit 16 is a device that controls the voltage conversion unit 30, the first element part 21, the second element part 22, the third element part 23, the fourth element part 24, and the like. The control unit 16 includes an information processing device having an information processing function, a calculation function, a control function, and the like, and may be composed of this information processing device, or may include the information processing device and other devices. For example, the control unit 16 may include a common control device for controlling all of the voltage conversion unit 30, the first element part 21, the second element part 22, the third element part 23, and the fourth element part 24, or may include separate control devices with one controlling some of the element parts and one controlling some other element parts.

The voltage detection unit 41 is a circuit that gives, to the control unit 16, a detected value (e.g., an analog voltage value) that can specify the value of the voltage applied to the first power path 81. The voltage detection unit 43 is a circuit that gives, to the control unit 16, a detected value (e.g., an analog voltage value) that can specify the value of the voltage applied to the third power path 83. The voltage detection unit 44 is a circuit that gives, to the control unit 16, a detected value (e.g., an analog voltage value) that can specify the value of the voltage applied to the fourth power path 84.

### Operation of In-vehicle Control Device

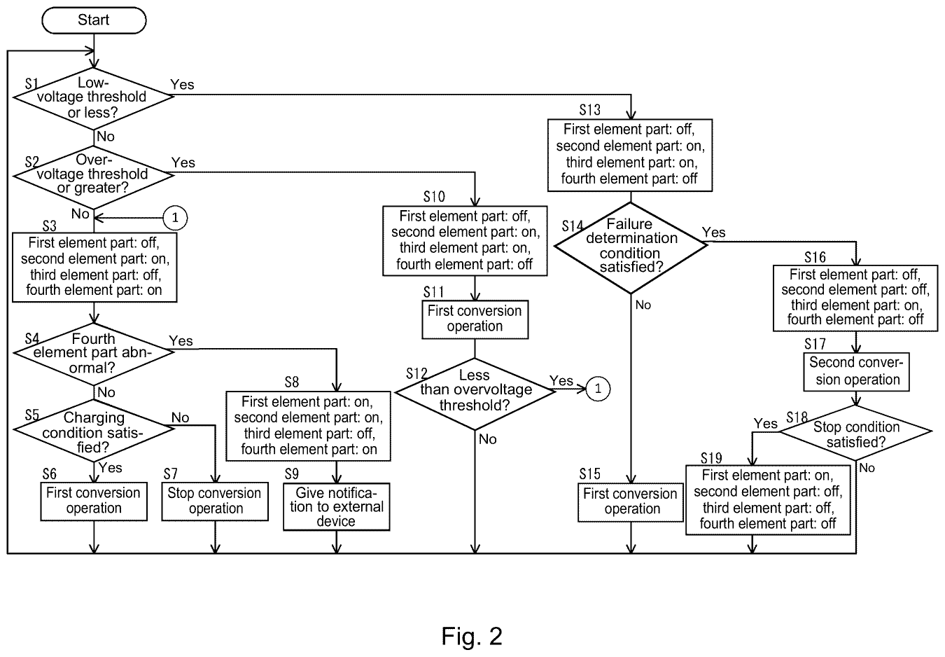

The following description relates to the control for a backup operation executed by the in-vehicle control device 10. FIG. 2 is a flowchart exemplifying a flow of control for the backup operation.

The control unit 16 starts the control for the backup operation shown in FIG. 2 when a predetermined start condition is satisfied. The above-mentioned “start condition” may be, for example, a condition that “the vehicle enters a starting state” or that a predetermined instruction is given from an external device (e.g., an external ECU), or may be any other condition. In the representative example described below, the control unit 16 determines that the above-mentioned start condition is satisfied when the vehicle in which the in-vehicle system 2 is installed enters the starting state, and starts the control for the backup operation shown in FIG. 2. A state where the vehicle is in the starting state means, for example, a situation where a starting switch, such as an ignition switch of a hybrid car or a power switch of an electric car, is switched from OFF to ON.

Note that after the start of the control shown in FIG. 2, the control unit 16 may continue the control of FIG. 2 until a predetermined end condition is satisfied, and may end the control of FIG. 2 when the predetermined end condition is satisfied. The predetermined end condition may be, for example, the condition that the starting switch of the vehicle is switched from ON to OFF, or may be any other condition.

After the start of the control for the backup operation shown in FIG. 2, the control unit 16 determines in step S1 whether or not the voltage of the first power path 81 is not greater than a low-voltage threshold Vth1. The low-voltage threshold Vth1 corresponds to an example of a first threshold value. If it is determined in step S1 that the voltage of the first power path 81 is greater than the low-voltage threshold Vth1, the control unit 16 determines in step S2 whether or not the voltage of the first power path 81 is not less than an overvoltage threshold Vth3. The overvoltage threshold Vth3 corresponds to an example of a voltage threshold. If it is determined in step S2 that the voltage of the first power path 81 is less than the overvoltage threshold Vth3, in step S3, the control unit 16 turns off the first element part 21, turns on the second element part 22, turns off the third element part 23, and turns on the fourth element part 24.

In this way, the control unit 16 turns on the fourth element part 24 if the voltage of the first power path 81 exceeds the low-voltage threshold Vth1 (first threshold) and is less than the overvoltage threshold Vth3 (voltage threshold), which is greater than the low-voltage threshold Vth1.

After step S3, the control unit 16 determines in step S4 whether or not the fourth element part 24 is abnormal. For example, the control unit 16 may determine that the fourth element part 24 is abnormal if the voltage of the second power path 82 immediately after step S3 is less than or equal to a predetermined reference value. Alternatively, the control unit 16 may determine that the fourth element part 24 is abnormal if the voltage given to the gate of the fourth element part 24 is an OFF voltage while the fourth element part 24 is controlled to be ON. Alternatively, the control unit 16 may determine that the fourth element part 24 is abnormal if there is a temperature abnormality such that the temperature near the fourth element part 24 exceeds a threshold temperature. In the present embodiment, the control unit 16 corresponds to an example of an abnormality detection unit and has a function to detect an abnormality in the fourth element part 24.

If it is determined in step S4 that the fourth element part 24 is not abnormal, the control unit 16 determines in step S5 whether or not the charging condition is satisfied. In a representative example, the charging condition is satisfied when the voltage of the fourth power path 84 is less than or equal to a predetermined value at least in a state where the voltage conversion unit 30 has stopped a charging operation (i.e., the voltage conversion unit 30 does not perform the first conversion operation). The control unit 16 determines in step S5 whether or not the above-mentioned charging condition is satisfied, and if it has determined that the charging condition is satisfied, the processing proceeds to step S6, and if it has determined that the charging condition is not satisfied, the processing proceeds to step S7. In a representative example, the charging condition is not satisfied when the voltage of the fourth power path 84 is greater than or equal to a full charge voltage, which is greater than a predetermined value (lower limit voltage) and the charging condition is not satisfied when the voltage of the fourth power path is greater than or equal to the above-mentioned predetermined value while the first conversion operation is stopped. On the other hand, the charging condition is satisfied when the voltage of the fourth power path is not greater than or equal to the full charge voltage during the first conversion operation.

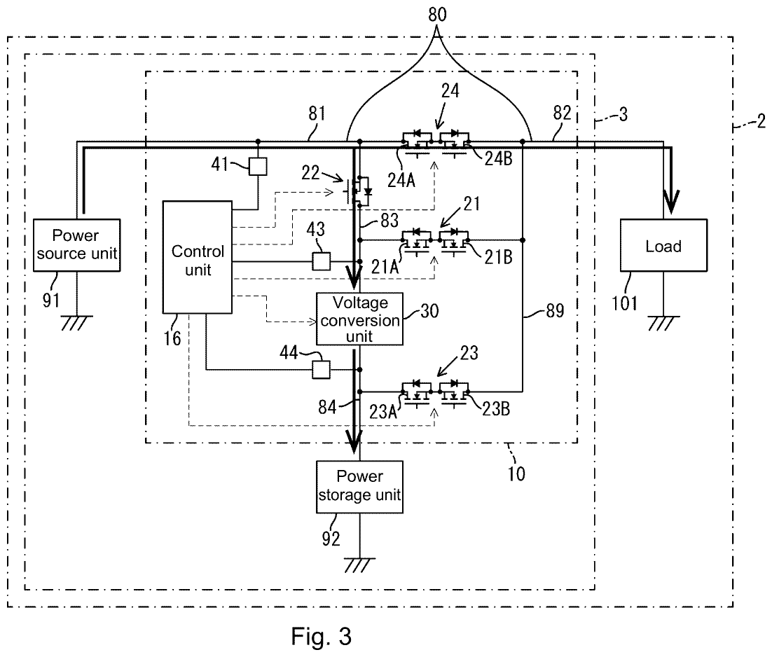

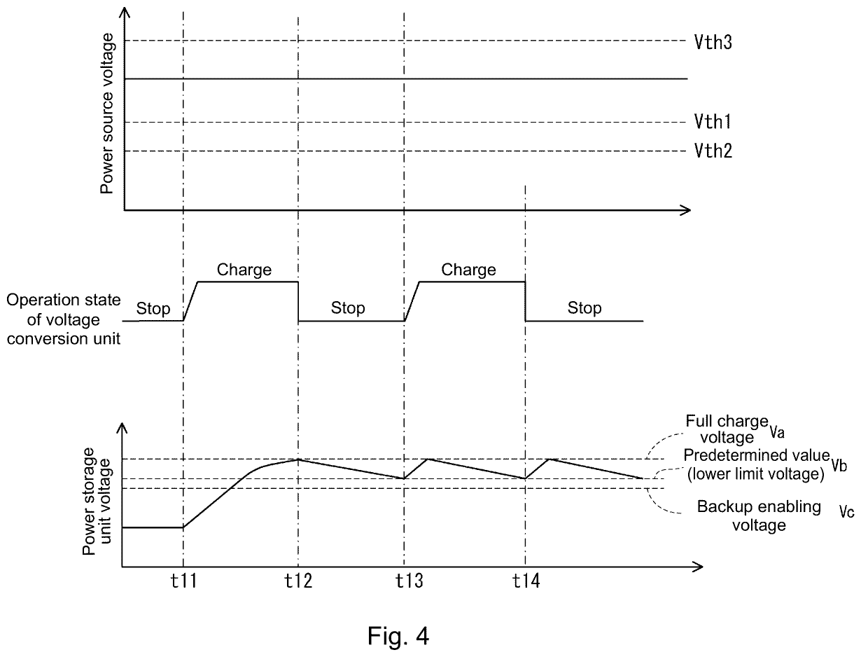

If the processing proceeds to step S6, the control unit 16 causes the voltage conversion unit 30 to perform the first conversion operation in step S6. The first conversion operation is a step-down or step-up operation to apply an output voltage of a first target value to the fourth power path 84. The first target value is, for example, greater than the above-mentioned predetermined value. When the processing in step S6 is performed, power is supplied in a flow as shown in FIG. 3. If the processing proceeds to step S7, the control unit 16 brings the voltage conversion unit 30 into a stopped state in step S7. FIG. 4 is an illustrative diagram showing changes in the normal state where the voltage of the first power path 81 exceeds the low-voltage threshold Vth1 (first threshold) and is less than the overvoltage threshold Vth3 (voltage threshold), which is greater than the low-voltage threshold Vth1. In the example in FIG. 4, the above-mentioned start condition is satisfied at time t11, and the control of FIG. 2 is started. In this example, after the start condition is satisfied at time t11, the first conversion operation (charging operation) is performed during the periods from t11 to 12 and from t13 to t14, in which the above-mentioned charging condition is satisfied, and the first conversion operation (charging operation) is not performed during the periods from t12 to 13 and from t14 onwards, in which the above-mentioned charging condition is not satisfied.

According to the present embodiment, therefore, if the voltage of the first power path 81 exceeds the low-voltage threshold Vth1 (first threshold) and the output voltage of the power storage unit 92 is less than or equal to a predetermined value, the control unit 16 causes the voltage conversion unit 30 to perform the first conversion operation with the second element part 22 allowing a current to flow from the first power path 81 side to the voltage conversion unit 30 side.

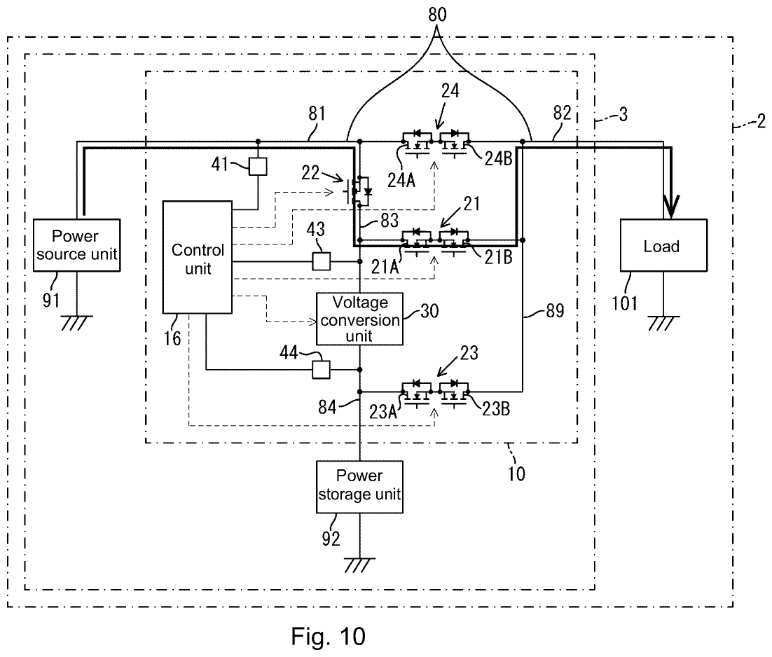

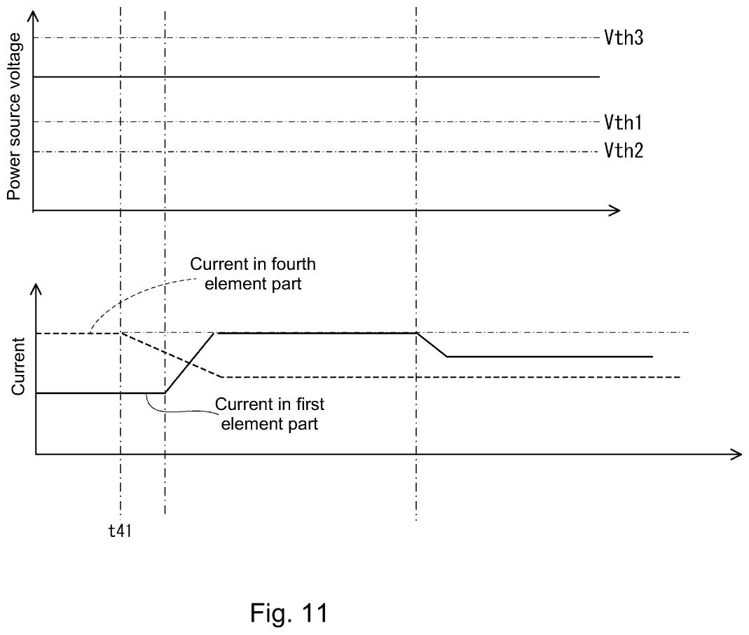

If it is determined in step S4 that the fourth element part 24 is abnormal, in step S8, the control unit 16 turns on the first element part 21, turns on the second element part 22, turns off the third element part 23, and turns on the fourth element part 24. After step S8, the control unit 16 notifies, in step S9, an external device (e.g., external ECU) of the fact that the fourth element part 24 is abnormal. According to the present embodiment, therefore, if an abnormality in the fourth element part 24 is detected by the above-mentioned abnormality detection unit, the control unit 16 turns on the first element part 21 with the second element part 22 allowing a current to flow from the first power path 81 side to the third power path 83 side. When the control unit 16 performs the operation as in step S4, as shown in FIG. 10, the fourth element part 24 is turned off, and power can be supplied to the second power path via the second element part 22 and the first element part 21. When performing the operation as shown in FIG. 10, the voltage conversion unit 30 may always be stopped, and may be controlled so as to perform the above-mentioned first conversion operation when the voltage of the fourth power path 84 drops to a value less than or equal to the above-mentioned predetermined value. FIG. 11 shows an example of a case where an abnormality in the fourth element part 24 is confirmed. In the example in FIG. 11, the fourth element part 24 is in the normal state before time t41, and the abnormality in the fourth element part 24 is confirmed at time t41. In this example, by keeping the first element part 21 OFF until time t41 and turning on the first element part 21 after time t41, a current flowing to the second power path 82 via the first element part 21 is secured. In the representative example shown in FIG. 11 and the like, the fourth element part 24 is ON even after an abnormality in the fourth element part 24 has been detected, but the fourth element part 24 may be switched OFF when an abnormality in the fourth element part 24 is detected.

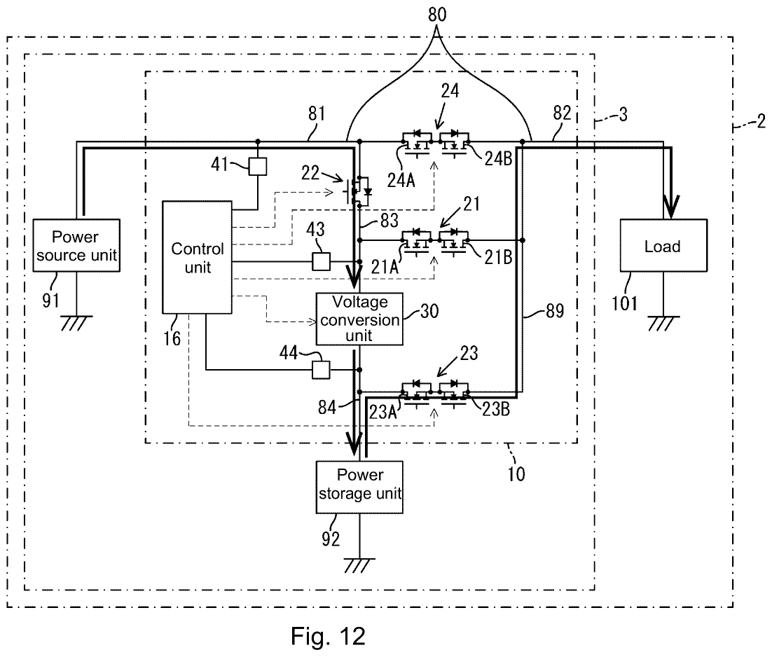

If it is determined in step S2 that the voltage of the first power path 81 is greater than or equal to the overvoltage threshold (voltage threshold), in step S10, the control unit 16 turns off the first element part 21, turns on the second element part 22, turns on the third element part 23, and turns off the fourth element part 24. After step S10, the control unit 16 performs the first conversion operation in step S11. According to the present embodiment, therefore, if the voltage of the first power path 81 is greater than or equal to the overvoltage threshold (voltage threshold), the control unit 16 causes the voltage conversion unit to perform the first conversion operation with the third element part 23 allowing a current to flow from the power storage unit 92 side to the second power path 82 side. When the control unit 16 performs the operations as in steps S10 and S11, the fourth element part 24 and the first element part 21 are turned off as shown in FIG. 12, and power based on the power storage unit 92 can be supplied to the second power path 82 via the third element part 23 while performing the first conversion operations. After step S11, the control unit 16 determines whether or not the voltage of the first power path 81 is less than the overvoltage threshold, and if it has determined that the voltage of the first power path 81 is greater than or equal to the overvoltage threshold, the processing proceeds to No in step S12 and the first conversion operation is continued. If it is determined that the voltage of the first power path 81 is less than the overvoltage threshold in step S12, the control unit 16 proceeds the processing to Yes in step S12 and proceeds to step S3, where the processing thereafter can be performed as normal state.

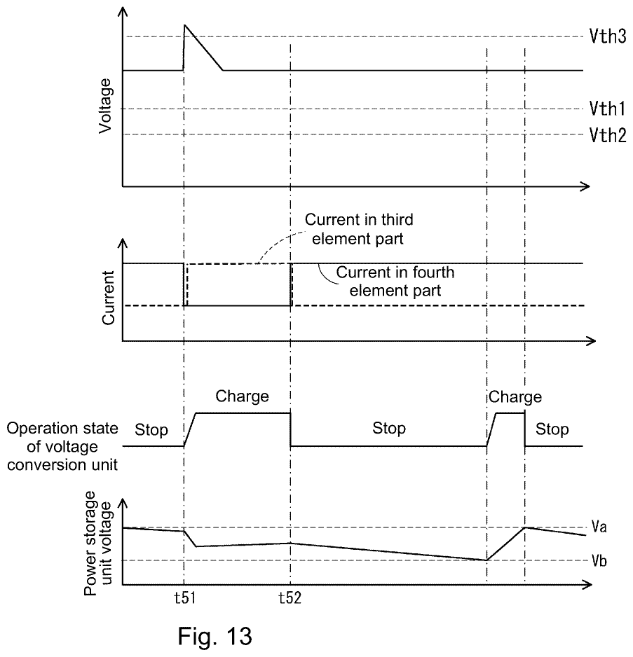

FIG. 13 shows an example where an overvoltage state occurs in the first power path 81. In the example in FIG. 13, the state before time 51 is a normal state, and the voltage of the first power path 81 increases to a value greater than or equal to the above-mentioned overvoltage threshold (voltage threshold) at time t51 and the voltage of the first power path 81 is determined to be less than the above-mentioned overvoltage threshold (voltage threshold) at time t52. In this example, from time t51 to time t52, the first conversion operation is performed to supply power through the third element part 23, and current supply through the fourth element part 24 is stopped. On the other hand, after times t52, the operation returns to the normal operation and a current can be supplied through the fourth element part 24. Thus, in this configuration, when the voltage of the first power path 81 is greater than or equal to the overvoltage threshold Vth3 (voltage threshold), the control unit 16 turns off the fourth element part 24 with the third element part 23 allowing a current to flow from the power storage unit 92 side to the second power path 82 side.

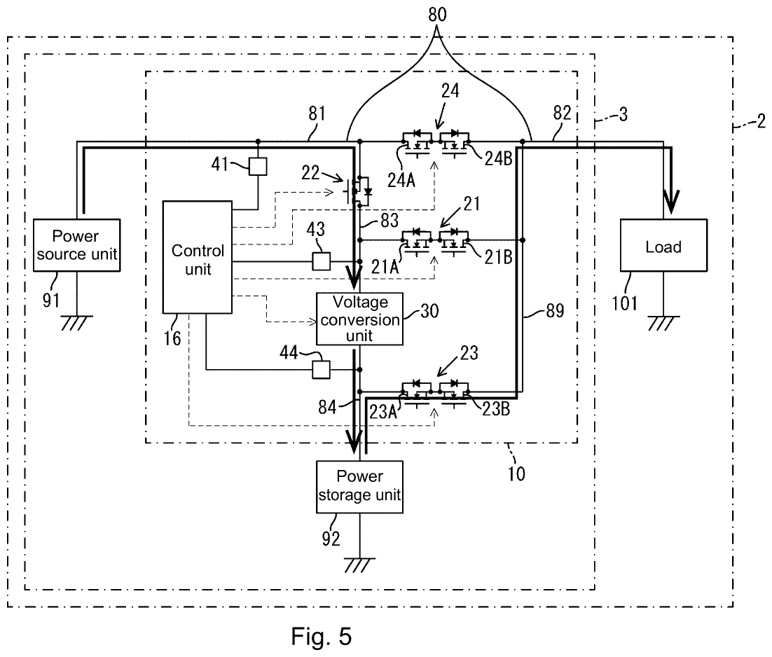

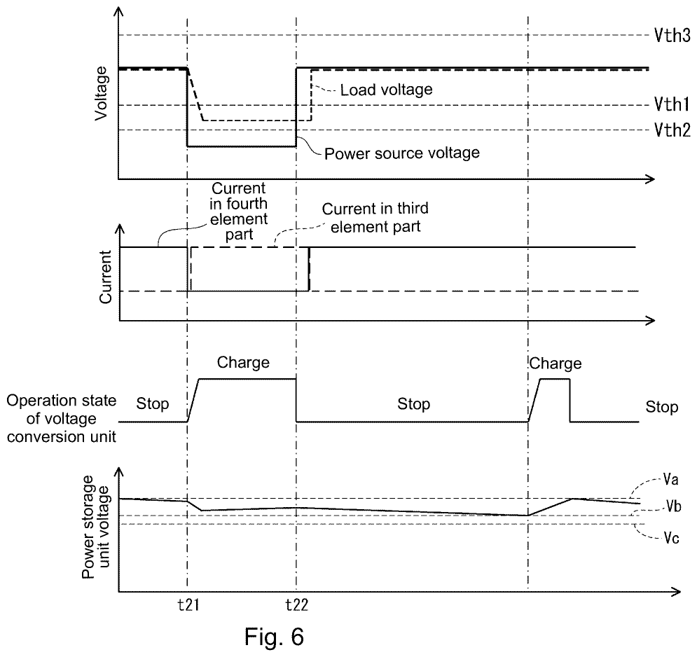

If it is determined in step S1 that the voltage of the first power path 81 is less than or equal to the low-voltage threshold (first threshold), in step S13, the control unit 16 turns off the first element part 21, turns on the second element part 22, turns on the third element part 23, and turns off the fourth element part 24. After step S13, the control unit 16 determines in step S14 whether or not the failure condition is satisfied and if it is determined that no failure condition is satisfied, the control unit 16 performs the first conversion operation in step S15. When the control unit 16 performs the operations as in step S15, the fourth element part 24 and the first element part 21 are turned off as shown in FIG. 5, and power based on the power storage unit 92 can be supplied to the second power path 82 via the third element part 23 while performing the first conversion operation. The example in FIG. 6 is an example of a case where the voltage of the first power path 81 is less than or equal to the low-voltage threshold (first threshold) and no failure determination condition is satisfied. In the example in FIG. 6, the voltage of the first power path 81 decreases to a value less than or equal to the above-mentioned low-voltage threshold (first threshold) and the failure determination condition is not satisfied at time t21, and the voltage of the first power path 81 returns to exceed the low-voltage threshold (first threshold) at time t22. In this example, from time t21 to time t22, the device can operate as shown in FIG. 5, and after time t22, the device can operate in the same manner as in the above-mentioned normal state.

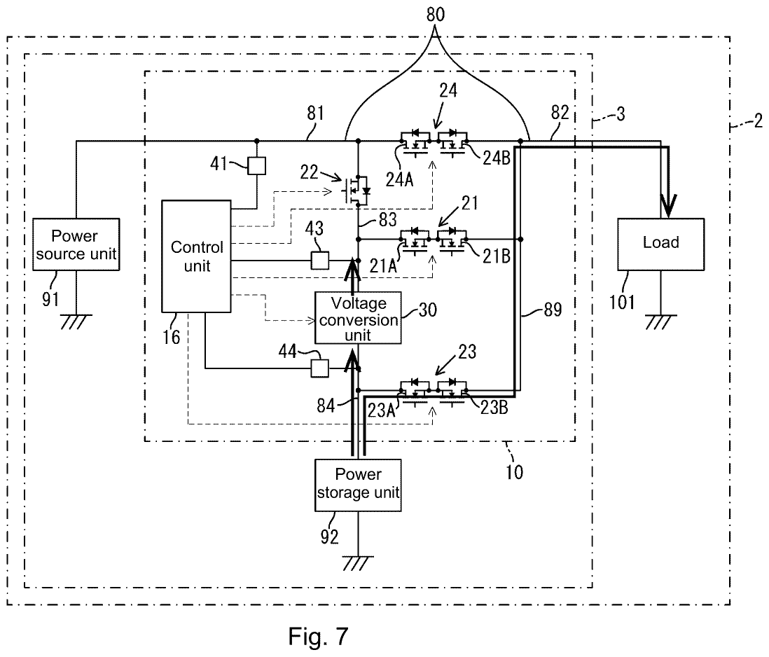

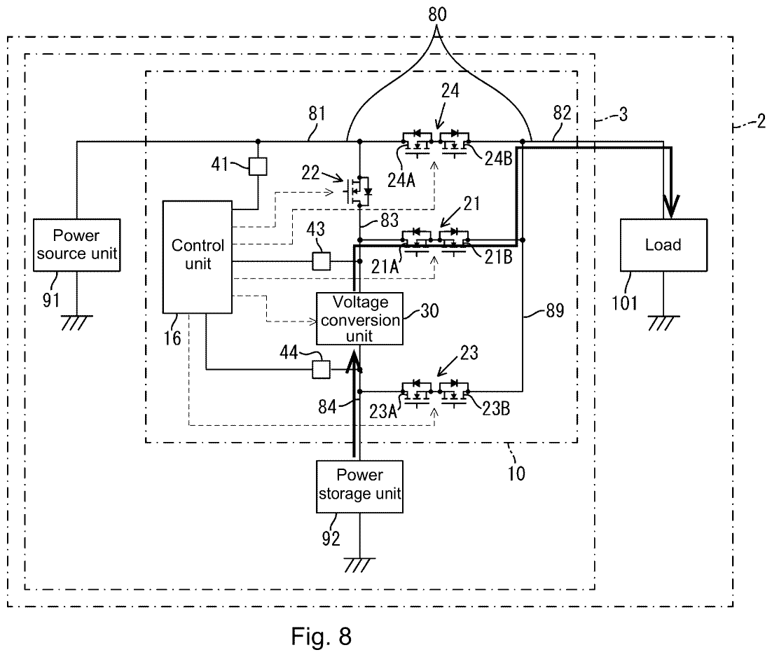

If it is determined in step S14 that the failure condition is satisfied, in step S16, the control unit 16 turns off the first element part 21, turns off the second element part 22, turns on the third element part 23, and turns off the fourth element part 24. After step S16, the control unit 16 performs the second conversion operation in step S17. After step S17, the control unit 16 determines in step S18 whether or not a stop condition is satisfied, and if it is determined that the stop condition is satisfied, the control unit 16 continues the second conversion operation while continuing the operations of the respective element parts in step S16. If it is determined in step S18 that the stop condition is satisfied, in step S19, the control unit 16 turns on the first element part 21, turns off the second element part 22, turns off the third element part 23, and turns off the fourth element part 24. When the processing proceeds to Yes in step S18, power supply is performed as shown in FIG. 7, and when the processing in step S19 is performed, power is supplied as shown in FIG. 8. The above-mentioned stop condition may be the condition that the voltage of the third power path 83 exceeds a predetermined value or that a certain amount of time has elapsed from the start of the second conversion operation in step S17, or may be any other condition.

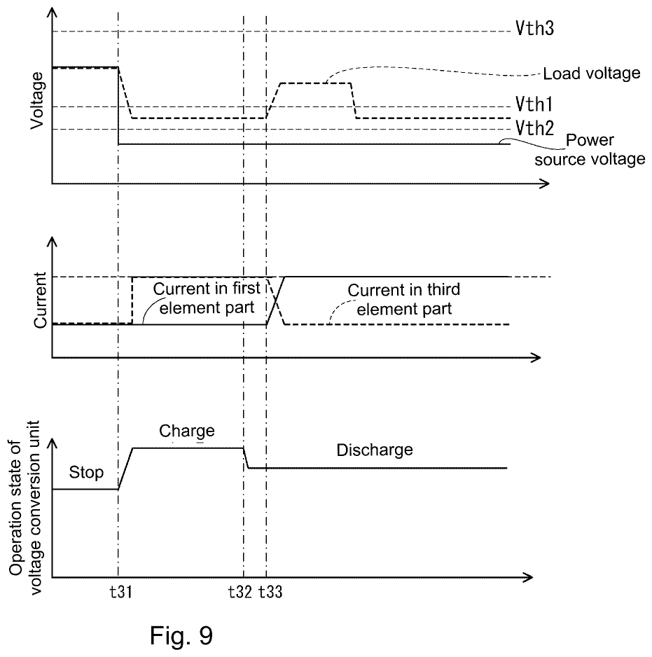

FIG. 9 illustrates an example of a case where the determination in step S14 results in Yes. In the example in FIG. 9, the voltage decreases to the low-voltage threshold Vt1 at time t31, and after time t31, the determination in step S1 results in Yes in the control of FIG. 2. The period from time t31 to time t32 is a period in which no failure determination condition is satisfied, and during this period, the determination in step S14 results in No and the processing in step S15 is continuously performed. The period from time t32 to time t33 is a period in which the failure determination condition is satisfied but the stop condition is not satisfied, and the period after time t33 is a period in which the failure determination condition is satisfied and the stop condition is satisfied.

Thus, in this configuration, if the voltage of the first power path 81 is less than or equal to the first threshold, the control unit 16 turns off the fourth element part 24 with the third element part 23 allowing a current to flow from the power storage unit 92 side to the second power path 82 side. Then, if the voltage of the first power path 81 is less than or equal to the first threshold and a predetermined condition is satisfied, as shown in FIG. 5, the control unit 16 causes the voltage conversion unit 30 to perform the first conversion operation with the third element part 23 allowing a current to flow from the power storage unit 92 side to the second power path 82 side.

In the present specification, the above-mentioned predetermined condition includes a condition that the predetermined failure determination condition is not satisfied. In other words, if the voltage of the first power path 81 is less than or equal to the first threshold and the failure determination condition is not satisfied, the control unit 16 operates to cause the voltage conversion unit 30 to perform the first conversion operation with the second element part 22 allowing a current to flow from the first power path 81 side to the voltage conversion unit 30 side. On the other hand, if the voltage of the first power path 81 is less than or equal to the first threshold and the failure determination condition is satisfied, the control unit 16 causes the voltage conversion unit 30 to perform the second conversion operation, with the second element part 22 interrupting a current flow from the voltage conversion unit 30 side to the first power path 81 side and the first element part 21 allowing a current to flow from the third power path 83 side to the second power path 82 side.

Also, if the voltage of the first power path 81 is less than or equal to the first threshold and the state is switched from the state where the failure determination condition is not satisfied to the state where the failure determination condition is satisfied, the control unit 16 can keep the third element part 23 ON before and after the switching. After the switching, the control unit 16 can cause the voltage conversion unit 30 to perform the second conversion operation, with the second element part 22 interrupting a current flow from the voltage conversion unit 30 side to the first power path 81 side and the first element part 21 allowing a current to flow from the third power path 83 side to the second power path 82 side. When the voltage conversion unit 30 satisfies a predetermined operation condition after the switching, the control unit 16 can operate to switch off the third element part 23.

In the representative example, the above-mentioned failure determination condition includes the condition that a current flows from the voltage conversion unit 30 side to the first power path 81 side via the second element part 22. In other words, in an representative example, if the voltage of the first power path 81 is less than or equal to the first threshold and no current flows from the voltage conversion unit 30 side to the first power path 81 side via the second element part 22, the processing in step S15 is performed and the control unit 16 causes the voltage conversion unit 30 to perform the first conversion operation with the second element part 22 allowing a current to flow from the first power path 81 side to the voltage conversion unit 30 side, and the third element part 23 allows a current to flow from the power storage unit 92 side to the second power path 82 side. On the other hand, if the voltage of the first power path 81 is less than or equal to the first threshold and a current flows from the voltage conversion unit 30 side to the first power path 81 side via the second element part 22, the processing in steps S16 onwards is performed, and the control unit 16 causes the voltage conversion unit 30 to perform the second conversion operation, with the second element part 22 interrupting a current flow from the voltage conversion unit 30 side to the first power path 81 side and the first element part 21 allowing a current to flow from the third power path 83 side to the second power path 82 side.

The failure determination condition may include the condition that the voltage of the first power path 81 is less than or equal to a second threshold Vth2, which is lower than the low-voltage threshold Vth1 (first threshold). In this case, if the voltage of the first power path 81 is less than or equal to the low-voltage threshold Vth1 (first threshold) and exceeds the second threshold Vth2, the processing in step S15 is performed and the control unit 16 causes the voltage conversion unit 30 to perform the first conversion operation with the second element part 22 allowing a current to flow from the first power path 81 side to the voltage conversion unit 30 side, and the third element part 23 allows a current to flow from the power storage unit 92 side to the second power path 82 side. Then, if the voltage of the first power path 81 is less than or equal to the second threshold, the processing in steps S16 onwards is performed and the control unit 16 causes the voltage conversion unit 30 to perform the second conversion operation, with the second element part 22 interrupting a current flow from the voltage conversion unit 30 side to the first power path 81 side and the first element part 21 allowing a current to flow from the third power path 83 side to the second power path 82 side.

The failure determination condition may include the condition that a predetermined failure signal is given to the in-vehicle control device 10 from an external device (e.g., external ECU) other than the in-vehicle control device 10. In this case, if the voltage of the first power path 81 is less than or equal to the first threshold and no failure signal is given from an external device, the processing in step S15 is performed and the control unit 16 causes the voltage conversion unit 30 to perform the first conversion operation with the second element part 22 allowing a current to flow from the first power path 81 side to the voltage conversion unit 30 side, and the third element part 23 allows a current to flow from the power storage unit 92 side to the second power path 82 side. On the other hand, if the voltage of the first power path 81 is less than or equal to the first threshold and a failure signal is given from an external device, the processing in steps S16 onwards is performed, and the control unit 16 causes the voltage conversion unit 30 to perform the second conversion operation, with the second element part 22 interrupting a current flow from the voltage conversion unit 30 side to the first power path 81 side and the first element part 21 allowing a current to flow from the third power path 83 side to the second power path 82 side.

In the present embodiment, during the period in which the voltage conversion unit 30 is caused to perform the first conversion operation with the third element part 23 allowing a current to flow from the power storage unit 92 side to the second power path 82 side, such as when performing the processing in step S10 or the processing in step S15, the control unit 16 sets power supplied from the voltage conversion unit 30 to the fourth power path 84 side to be larger than power supplied to the second power path 82 side via the third element part 23.

### Examples of Advantageous Effects

The in-vehicle control device 10 can charge the power storage unit 92 while applying a desired voltage to the fourth power path 84, by causing the voltage conversion unit 30 to perform the first conversion operation with the second element part 22 allowing a current to flow from the first power path 81 side to the voltage conversion unit 30 side. On the other hand, the in-vehicle control device 10 can supply power to the second power path 82 while applying a desired voltage to the third power path 83, by causing the voltage conversion unit 30 to perform the second conversion operation with the first element part 21 allowing a current to flow from the voltage conversion unit 30 side to the second power path 82 side. In other words, the in-vehicle control device 10 can adjust a charging voltage when charging the power storage unit 92 and a discharging voltage when discharging the power storage unit 92 with a simpler configuration, and in some cases, the second element part 22 can interrupt a current flow from the voltage conversion unit 30 side to the first power path 81 side. Furthermore, since the third element part 23 is provided and can allow a current to flow from the power storage unit 92 side to the second power path 82 side, the power storage unit 92 can be discharged through a path other than the path in which the voltages are adjusted by the voltage conversion unit 30. Furthermore, since the third element part 23 is capable of interrupting a current flow from the second power path 82 side to the power storage unit 92 side, in some cases, it is possible to interrupt a current flow into the power storage unit 92 from the second power path 82 side through the third element part 23.

In the in-vehicle control device 10, since the fourth element part 24 can allow a current to flow from the first power path 81 side to the second power path 82 side, power based on the power source unit 91 can be supplied directly to the second power path 82 via the fourth element part 24. On the other hand, in some cases, the fourth element part 24 can interrupt a current flow from the second power path 82 side to the first power path 81 side.

By turning on the fourth element part 24 if the voltage of the first power path 81 exceeds the first threshold, the in-vehicle control device 10 can directly supply power based on the power source unit 91 to the second power path 82 while suppressing a loss. On the other hand, if the voltage of the first power path 81 is less than or equal to the first threshold, the control unit 16 can turn off the fourth element part 24 with the third element part 23 allowing a current to flow from the power storage unit 92 side to the second power path 82 side, so that it is possible to keep the first power path 81 from affecting the second power path 82 via the fourth element part 24 and let a discharge current flow from the power storage unit 92 to the second power path 82 via the third element part 23.

In the in-vehicle control device 10, if an abnormality in the fourth element part 24 is detected by the abnormality detection unit, the control unit 16 can turn on the first element part 21 with the second element part 22 allowing a current to flow from the first power path 81 side to the third power path 83 side, so that paths of the second element part 22 and the first element part 21 can be used to supply power from the first power path 81 side to the second power path 82 side. On the other hand, the first element part 21 can also be turned off, and in this case, a current can be prevented from flowing into the third power path 83 side from the second power path 82 side via the first element part 21.

By turning on the fourth element part 24 if the voltage of the first power path 81 is large enough to exceed the first threshold but is not large enough to reach the above-mentioned voltage threshold, the in-vehicle control device 10 can directly supply power based on the power source unit 91 to the second power path 82 while suppressing a loss. On the other hand, if the voltage of the first power path 81 increases too high to the extent that it is greater than or equal to the above-mentioned voltage threshold, the in-vehicle control device 10 can turn off the fourth element part 24 with the third element part 23 allowing a current to flow from the power storage unit 92 side to the second power path 82 side, so that it is possible to keep the overvoltage of the first power path 81 from affecting the second power path 82 via the fourth element part 24 and let a discharge current flow from the power storage unit 92 to the second power path 82 via the third element part 23.

If the predetermined condition is satisfied even when the voltage of the first power path 81 drops to a value less than or equal to the first threshold, the in-vehicle control device 10 can cause the voltage conversion unit 30 to perform the first conversion operation to supply power to the power storage unit 92 side, and while supplying power to the power storage unit 92 side, the in-vehicle control device 10 can also supply power to the second power path 82 side via the third element part 23.

If the failure determination condition is not satisfied even when the voltage of the first power path 81 drops to a value less than or equal to the first threshold, the in-vehicle control device 10 can cause the voltage conversion unit 30 to perform the first conversion operation to charge the power storage unit 92, with the second element part 22 allowing a current to flow to the voltage conversion unit 30 side. On the other hand, if the failure determination condition is satisfied, the in-vehicle control device 10 can supply the voltage adjusted based on the voltage conversion operation of the voltage conversion unit 30 to the second power path 82 while interrupting a reverse flow to the first power path 81 side.

If the voltage of the first power path 81 is less than or equal to the first threshold and the state is changed to a state in which the failure determination condition is not satisfied, the in-vehicle control device 10 can turn on the third element part 23 to quickly supply power to the second power path 82 from the power storage unit 92. If the state is switched from a state in which the failure determination condition is not satisfied to a state in which the failure determination condition is satisfied when the voltage of the first power path 81 is less than or equal to the first threshold, it is possible, after the switching, to supply power whose voltage is adjusted by the second conversion operation to the second power path 82 via the third power path 83 and the first element part 21, while preventing a reverse flow to the first power path 81 side. Moreover, since the in-vehicle control device 10 can keep the third element part 23 ON before and after the switching, it is possible to maintain power supply from the power storage unit 92 to the second power path 82 via the third element part 23 even if the output of the voltage conversion unit 30 rises slowly after the above-mentioned switching. Furthermore, if the voltage conversion unit 30 satisfies a predetermined operation condition after the switching, the in-vehicle control device 10 can switch off the third element part 23 to narrow down the discharge path, from among the paths of the first element part 21 and the third element part 23, to the path of the first element part 21.

If the voltage of the first power path 81 is less than or equal to the first threshold, the in-vehicle control device 10 confirms that no current flows to the first power path 81 side via the second element part 22, i.e., that it is highly likely that no ground fault has occurred in the first power path 81, and then causes the voltage conversion unit 30 to perform the first conversion operation to charge the power storage unit 92. Then, the in-vehicle control device 10 can perform discharge of power via the third element part 23 in parallel with supply of power to the power storage unit 92 side due to the above-mentioned first conversion operation. On the other hand, if the voltage of the first power path 81 is less than or equal to the first threshold and a current flows to the first power path 81 side via the second element part 22, i.e., it is highly likely that a ground fault has occurred in the first power path 81, the in-vehicle control device 10 can interrupt a current flow through the second element part 22 to the first power path 81 side and can suppress the ground fault from affecting the third power path 83 side. Then, by causing the voltage conversion unit 30 to perform the second conversion operation with the first element part 21 allowing a current to flow to the second power path 82 side, it is possible to supply power whose voltage is adjusted by the voltage conversion unit 30 to the second power path 82 while suppressing the effect of the ground fault.

If the voltage of the first power path 81 is less than or equal to the first threshold, the in-vehicle control device 10 confirms that the voltage exceeds the second threshold, i.e., that the voltage of the first power path 81 is not too low, and then can cause the voltage conversion unit 30 to perform the first conversion operation to charge the power storage unit 92. Then, the in-vehicle control device 10 can perform discharge of power via the third element part 23 in parallel with supply of power to the power storage unit 92 side due to the above-mentioned first conversion operation. On the other hand, if the voltage of the first power path 81 is less than or equal to the second threshold, i.e., the voltage of the first power path 81 is too low, it is possible to interrupt a current flow through the second element part 22 to the first power path 81 side, and thus even if a ground fault occurs in the first power path 81, it is possible to suppress the ground fault from affecting the third power path 83 side. Then, by causing the voltage conversion unit 30 to perform the second conversion operation with the first element part 21 allowing a current to flow to the second power path 82 side, it is possible to supply power whose voltage is adjusted by the voltage conversion unit 30 to the second power path 82 while suppressing the effect of the voltage drop at the first power path 81.

If the voltage of the first power path 81 is less than or equal to the first threshold, the in-vehicle control device 10 confirms that no failure signal has been given from an external device, and then can cause the voltage conversion unit 30 to perform the first conversion operation to charge the power storage unit 92. Then, the in-vehicle control device 10 can discharge power via the third element part 23 in parallel with supply of power to the power storage unit 92 side due to the first conversion operation. On the other hand, if a failure signal is generated when the voltage of the first power path 81 is less than or equal to the first threshold, it is possible to cause the voltage conversion unit 30 to perform the second conversion operation with the second element part 22 interrupting a current flow to the first power path 81 side and the first element part 21 allowing a current to flow to the second power path 82 side. Accordingly, even if a ground fault or the like occurs in the first power path 81 when a failure signal is generated, it is possible to supply power whose voltage is adjusted by the voltage conversion unit 30 to the second power path 82 while suppressing the effect of the failure signal.

When performing the first conversion operation and the discharge through the third element part 23 in parallel, the in-vehicle control device 10 can set a larger charging power based on the first conversion operation relative to a discharging power via the third element part 23. Therefore, when the above-mentioned parallel operations are performed, it is possible to supply power to the second conductive path while ensuring a charging current to the power storage unit 92 more reliably.

If the output voltage of the power storage unit 92 drops to a value less than or equal to a predetermined value, the in-vehicle control device 10 can charge the power storage unit 92 through the first conversion operation.

### Second Embodiment

The following description relates to a second embodiment.

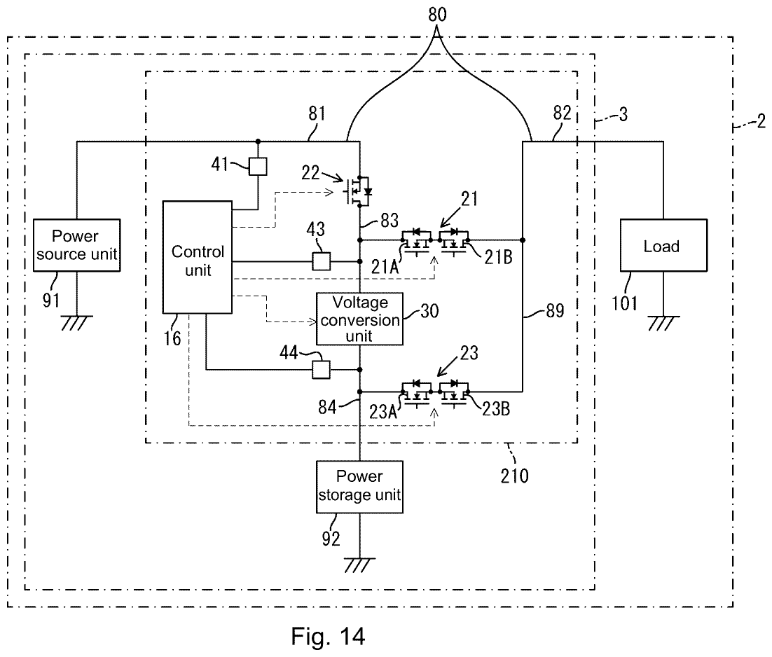

The circuit configuration of an in-vehicle control device 210 of the second embodiment shown in FIG. 14 differs from that of the in-vehicle control device 10 of the first embodiment in that the fourth element part 24 is not provided, and the other circuit configuration is identical to that of the in-vehicle control device 10. The control of the in-vehicle control device 210 differs from the control in FIG. 2 in that the control of the fourth element part 24 is omitted, and the processing in steps S4, S8, and S9 is omitted, whereas the other control is identical to that of FIG. 2. In the control of the in-vehicle control device 210 in FIG. 2, step S3 is followed by step S5.

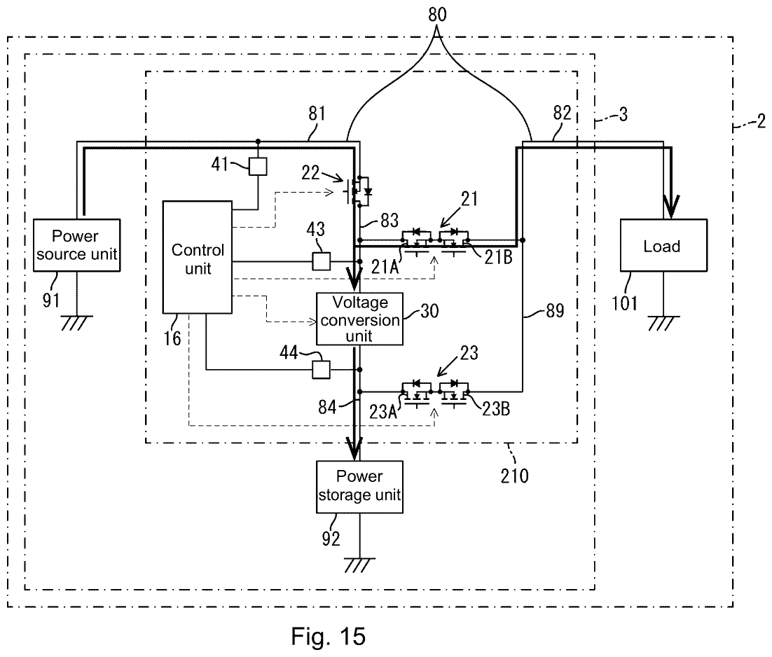

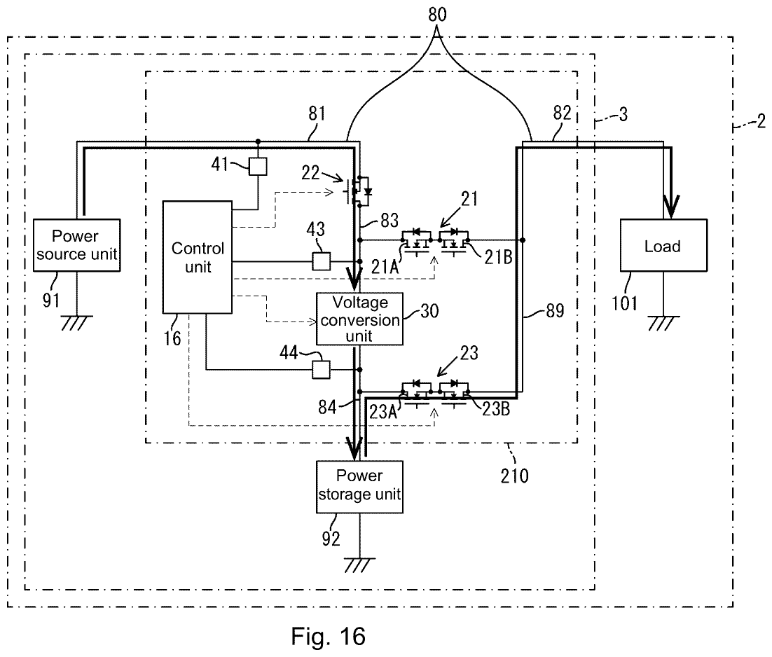

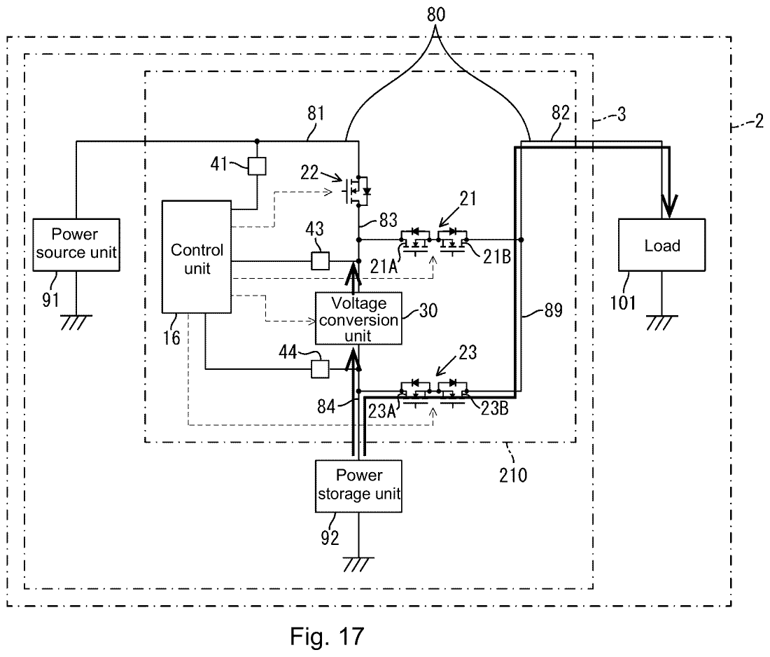

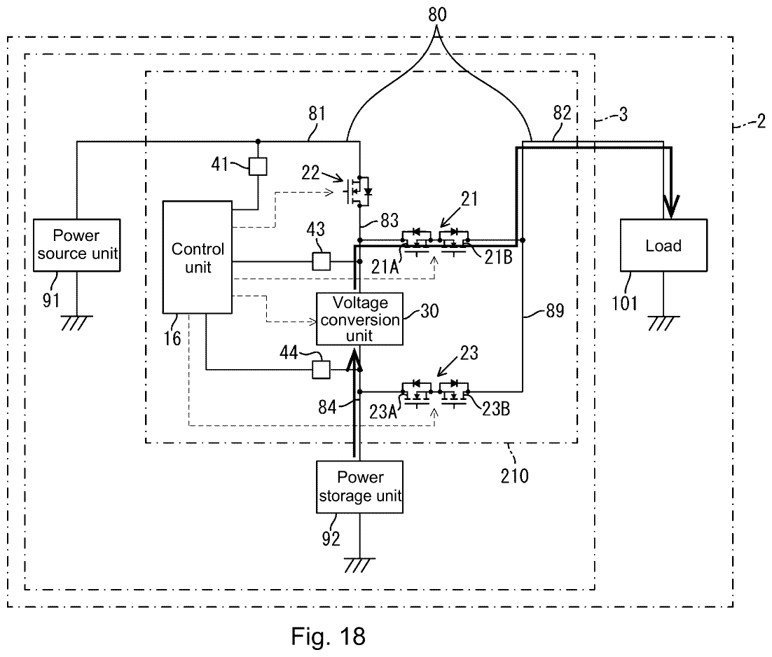

In the in-vehicle control device 210 of the second embodiment, when performing the processing in step S6 when the voltage of the first power path 81 is in the above-mentioned normal state, power is supplied as shown in FIG. 15. On the other hand, when performing the processing in step S15 when the voltage of the first power path 81 is less than or equal to the low voltage threshold and no failure determination condition is satisfied, power is supplied as shown in FIG. 16. When performing the processing in step S16 immediately after the failure determination condition is satisfied when the voltage of the first power path 81 is less than or equal to the low-voltage threshold, power is supplied as shown in FIG. 17. On the other hand, when performing the processing in step S19 when the above-mentioned stop condition is satisfied, power is supplied as shown in FIG. 18. In this way, even if the fourth element part 24 in the configuration of FIG. 1 is not provided, it is possible to perform control similar to that in the first embodiment.

### Third Embodiment

The following description relates to a third embodiment.

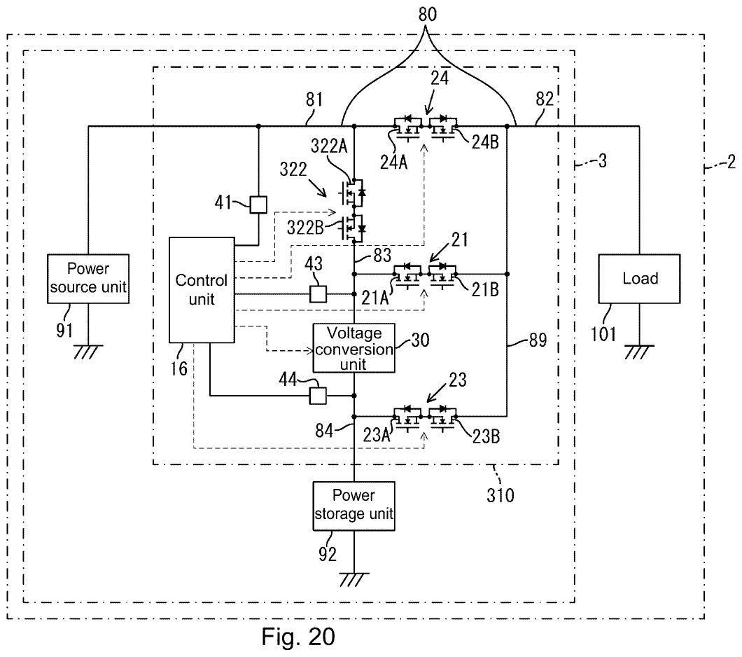

The circuit configuration of an in-vehicle control device 310 of the third embodiment shown in FIG. 20 differs from the circuit configuration of the in-vehicle control device 10 of the first embodiment only in that the second element part 22 of the in-vehicle control device 10 in FIG. 1 is replaced by a second element part 322, whereas the remaining circuit configuration is identical to that of the in-vehicle control device 10. The control performed by the in-vehicle control device 310 differs from the control of the first embodiment in FIG. 2 only in that semiconductor switches 322A and 322B are turned on instead of the second element part being turned on in steps S3, S8, and S13 in FIG. 2, the semiconductor switches 322A and 322B are turned off instead of the second element part being turned off in steps S16 and S19, the second element part 322 is turned off in step S10, and the second conversion operation is performed in step S11, whereas the other control is identical to the control of the first embodiment in FIG. 2.

In the in-vehicle control device 310 of FIG. 20, the second element part 322 is configured to interrupt a current flow between the first power path 81 and the third power path 83 through the second element part 322 in both directions when the second element part 322 is OFF, and to allow a current to flow from the first power path 81 to the third power path 83 through the second element part 322 when the second element part 322 is ON. The semiconductor switches 322A and 322B constituting the second element part 322 are connected to each other in opposite orientations, and are each composed of an FET. In the example in FIG. 1, the drain of the semiconductor switch 322A is shorted to the first power path 81, the drain of the semiconductor switch 322B is shorted to the third power path 83, and the source of the semiconductor switch 322A and the source of semiconductor switch 322B are shorted to each other. A state where the second element part 322 is OFF means that both the semiconductor switches 322A and 322B are OFF. When the second element part 322 is OFF, a current flow through the second element part 322 is interrupted in both directions, namely, both a current flow from the first power path 81 side to the third power path 83 side and a current flow from the third power path 83 side to the first power path 81 side are interrupted. A state where the second element part 322 is ON means that both the semiconductor switches 322A and 322B are ON. When the second element part 322 is ON, a current is allowed to flow through the second element part 322 in both directions, namely, both a current flow from the first power path 81 side to the third power path 83 side and a current flow from the third power path 83 side to the first power path 81 side are allowed.

Also, in the in-vehicle control device 310 in FIG. 20, as shown in FIG. 2, if the voltage of the first power path 81 exceeds the low-voltage threshold Vth1 (first threshold) and is less than the overvoltage threshold (voltage threshold), which is greater than the low-voltage threshold Vth1, (that is, if No in step S2), in step S3, the control unit 16 turns on the second element part 322. On the other hand, if it is determined in step S2 in FIG. 2 that the voltage of the first power path 81 is greater than or equal to the overvoltage threshold (voltage threshold), in step S10, the control unit 16 performs processing different from in the example of FIG. 2, and turns on the first element part 21, turns off the second element part 22, turns on the third element part 23, and turns off the fourth element part 24. Then, in the subsequent step S11, the control unit 16 performs processing different from in the example of FIG. 2, and causes the voltage conversion unit 30 to perform the second conversion operation. In this way, if the voltage of the first power path 81 is greater than or equal to the overvoltage threshold (voltage threshold), the control unit 16 turns on the first element part 21 to allow a current to flow through the first element part 21 from the third power path 83 side to the second power path 82 side and turns off the second element part 322, and in this state, the control unit 16 causes the voltage conversion unit 30 to perform the second conversion operation. When this operation is performed, current flow between the first power path 81 and the third power path 83 is interrupted in both directions, and in this state, the voltage conversion unit 30 applies an output voltage to the third power path 83 based on the power from the power storage unit 92, and power is supplied from the third power path 83 to the second power path 82. During such a power supply operation, the fourth element part 24 interrupts current flow between the first power path 81 and the second power path 82 through the fourth element part 24 in both directions. Also in this example, after the processing in step S11, it is sufficient to perform the determination processing in step S12, and if the voltage of the first power path 81 is less than the above-mentioned overvoltage threshold (voltage threshold), it is sufficient to perform the processing in steps S3 onwards.

The above-mentioned in-vehicle control device 310 turns on the second element part 22 to allow power supply from the first power path 81 side to the voltage conversion unit 30 side, if the voltage of the first power path 81 exceeds the low-voltage threshold Vth1 (first threshold) and is less than the overvoltage threshold (voltage threshold). On the other hand, if the voltage of the first power path 81 increases too high to a value greater than or equal to the above-mentioned overvoltage threshold (voltage threshold), the in-vehicle control device 310 can cause the voltage conversion unit 30 to perform the second conversion operation by turning off the second element part 22 to interrupt a current flow from the first power path 81 side to the third power path 83 side and to allow a current to flow from the third power path 83 side to the second power path 82 side via the first element part 21. Specifically, the fourth element part 24 is turned off and the above-mentioned operation is performed, and thus it is possible to supply power adjusted by the voltage conversion unit 30 to the second power path 82 in a stable manner while keeping an overvoltage of the first power path 81 from affecting the second power path 82.

### Other Embodiments

The present disclosure is not limited to the embodiments described with reference to the above description and the drawings. For example, the features of the embodiments described above or below can be combined in any way as long as they do not contradict each other. Also, any feature of the embodiments described above or below can be omitted if it is not explicitly indicated as an essential feature. Furthermore, the above-mentioned embodiments may be modified as follows.

In the above-mentioned embodiments, the power storage unit 92 is provided outside the in-vehicle control device 10, but a configuration is also possible in which the power storage unit 92 is included in the in-vehicle control device 10.

Although the fourth element part is turned on if the voltage of the first power path 81 exceeds the low-voltage threshold Vth1 (first threshold) and is less than the overvoltage threshold Vth3 (voltage threshold), which is greater than the low-voltage threshold Vth1, the fourth element part may also be turned on regardless of whether or not the voltage of the first power path 81 exceeds the low-voltage threshold Vth1 (first threshold) and is less than the overvoltage threshold Vth3 (voltage threshold).

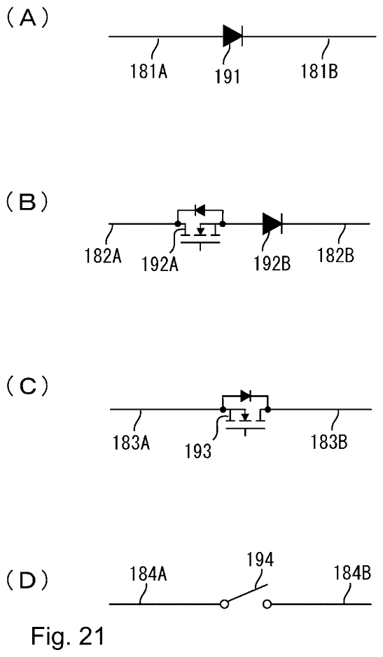

In the above-mentioned embodiments, the first element part 21 is constituted by two FETs, but as shown in FIG. 21(A), the first element part 21 may also be constituted only by a diode 191. In this case, it is sufficient that a conductive path 181A is electrically connected to the third power path 83 and a conductive path 181B is electrically connected to the second power path 82. Alternatively, as shown in FIG. 21(B), the first element part 21 may be a switch part in which a switch element 192A (e.g., FET) and a diode 192B are connected in series to each other. In this case, it is sufficient that a conductive path 182A is electrically connected to the third power path 83 and a conductive path 182B is electrically connected to the second power path 82. Alternatively, as shown in FIG. 21(C), the first element part 21 may only include a switch element 193 (e.g., FET). In this case, it is sufficient that a conductive path 183A is electrically connected to the third power path 83 and a conductive path 183B is electrically connected to the second power path 82. Alternatively, as shown in FIG. 21(D), the first element part 21 may be a switch part 194 constituted by a known semiconductor switch or mechanical relay other than a FET. In this case, it is sufficient that a conductive path 184A is electrically connected to the third power path 83 and a conductive path 184B is electrically connected to the second power path 82.

Although the second element part 22 includes a single FET in the first embodiment and includes two FETs in the third embodiment, the present disclosure is not limited to the examples. For example, the configuration of FIG. 21(A) may be employed and the second element part 22 may be constituted only by the diode 191. In this case, it is sufficient that the conductive path 181A is electrically connected to the first power path 81 and the conductive path 181B is the third power path 83. Alternatively, the configuration of FIG. 21(B) may be employed and the second element part 22 may be a switch part in which the switch element 192A (e.g., FET) and the diode 192B are connected in series to each other. In this case, it is sufficient that the conductive path 182A is electrically connected to the first power path 81 and the conductive path 182B is the third power path 83. Alternatively, the configuration of FIG. 21(D) may be employed and the second element part 22 may be the switch part 194 constituted by a known semiconductor switch or mechanical relay other than a FET. In this case, it is sufficient that the conductive path 184A is electrically connected to the first power path 81 and the conductive path 184B is the third power path 83.

In the above-mentioned embodiments, the third element part 23 includes two FETs, but the configuration of FIG. 21(A) may be employed and the third element part 23 may also be constituted only by the diode 191. In this case, it is sufficient that the conductive path 181A is electrically connected to the fourth power path 84 and the conductive path 181B is electrically connected to the second power path 82. Alternatively, the configuration of FIG. 21(B) may be employed, and the third element part 23 may be a switch part in which the switch element 192A (e.g., FET) and the diode 192B are connected in series to each other. In this case, it is sufficient that the conductive path 182A is electrically connected to the fourth power path 84 and the conductive path 182B is electrically connected to the second power path 82. Alternatively, the configuration of FIG. 21(C) may be employed and the third element part 23 may only include the switch element 193 (e.g., FET). In this case, it is sufficient that the conductive path 183A is electrically connected to the fourth power path 84 and the conductive path 183B is electrically connected to the second power path 82. Alternatively, the configuration of FIG. 21(D) may be employed and the third element part 23 may be the switch part 194 constituted by a known semiconductor switch or mechanical relay other than a FET. In this case, it is sufficient that the conductive path 184A is electrically connected to the fourth power path 84 and the conductive path 184B is electrically connected to the second power path 82.

In the above-mentioned embodiments, the fourth element part 24 includes two FETs, but the configuration of FIG. 21(A) may be employed and the fourth element part 24 may also be constituted only by the diode 191. In this case, it is sufficient that the conductive path 181A is the first power path 81 and the conductive path 181B is the second power path 82. Alternatively, the configuration of FIG. 21(B) may be employed and the fourth element part 24 may be a switch part in which the switch element 192A (e.g., FET) and the diode 192B are connected in series to each other. In this case, it is sufficient that the conductive path 182A is the first power path 81 and the conductive path 182B is the second power path 82. Alternatively, the configuration of FIG. 21(C) may be employed and the fourth element part 24 may only include the switch element 193 (e.g., FET). In this case, it is sufficient that the conductive path 183A is the first power path 81 and the conductive path 183B is the second power path 82. Alternatively, the configuration of FIG. 21(D) may be employed and the fourth element part 24 may be a switch part 194 constituted by a known semiconductor switch or mechanical relay other than a FET. In this case, it is sufficient that the conductive path 184A is the first power path 81 and the conductive path 184B is the second power path 82.

The in-vehicle control device 310 of the third embodiment is configured such that the second element part 22 of the in-vehicle control device 10 of the first embodiment is replaced by the second element part 322, but the in-vehicle control device 210 may also be configured such that the second element part 22 of the in-vehicle control device 210 of the second embodiment is replaced by the second element part 322 in the same manner. In this example, the processing other than in steps S10 to S12 is performed in the same manner as in the second embodiment and the processing in steps S10 to S12 is performed in the same manner as in the third embodiment, but this example differs from the third embodiment in that the control of the fourth element part is omitted.

The embodiments disclosed herein are in all respects to be considered illustrative and not restrictive. The scope of the disclosure is not limited to the embodiments disclosed herein, but is indicated by the claims, which are intended to include all modifications within the meaning and scope equivalent to the claims.

1. An in-vehicle control device for use in an in-vehicle system provided with: a power source unit for supplying power; a power storage unit that is not the power source unit; a first power path to which a voltage based on the power source unit is applied; a second power path serving as a path for supplying power supplied from the first power path to a load; a third power path that is not the first power path and the second power path; and a fourth power path to which a voltage based on the power storage unit is applied, the in-vehicle control device being configured to control power supply from the power storage unit and comprising:
a voltage conversion unit configured to perform a first conversion operation of converting a voltage applied to the third power path and applying an output voltage to the fourth power path, and a second conversion operation of converting a voltage applied to the fourth power path and applying an output voltage to the third power path;
a control unit configured to control the voltage conversion unit;
a first element part capable of allowing a current to flow from a voltage conversion unit side to a second power path side and interrupting a current flow from the second power path side to the voltage conversion unit side;
a second element part capable of allowing a current to flow from a first power path side to a voltage conversion unit side and interrupting a current flow from the voltage conversion unit side to the first power path side; and
a third element part capable of allowing a current to flow from a power storage unit side to a second power path side and interrupting a current flow from the second power path side to the power storage unit side.

2. The in-vehicle control device according to claim 1, further comprising:
a fourth element part capable of allowing a current to flow from a first power path side to a second power path side and interrupting a current flow from the second power path side to the first power path side.

3. The in-vehicle control device according to claim 2,
wherein the fourth element part is configured to interrupt a current flow between the first power path and the second power path through the fourth element part in both directions when the fourth element part is OFF, and to allow a current to flow from the first power path to the second power path through the fourth element part when the fourth element part is ON,
if a voltage of the first power path exceeds a first threshold, the control unit turns on the fourth element part, and
if the voltage of the first power path is less than or equal to the first threshold, the control unit turns off the fourth element part with the third element part allowing a current to flow from the power storage unit side to the second power path side.

4. The in-vehicle control device according to claim 2, further comprising
an abnormality detection unit configured to detect an abnormality in the fourth element part,
wherein the first element part is configured to interrupt a current flow between the third power path and the second power path through the first element part in both directions when the first element part is OFF, and to allow a current to flow from the third power path to the second power path through the first element part when the first element part is ON, and
if an abnormality in the fourth element part is detected by the abnormality detection unit, the control unit turns on the first element part with the second element part allowing a current to flow from the first power path side to the third power path side.

5. The in-vehicle control device according to claim 2,
wherein the fourth element part is configured to interrupt a current flow between the first power path and the second power path through the fourth element part in both directions when the fourth element part is OFF, and to allow a current to flow from the first power path to the second power path through the fourth element part when the fourth element part is ON,
if a voltage of the first power path exceeds a first threshold and is less than a voltage threshold, which is greater than the first threshold, the control unit turns on the fourth element part, and
if the voltage of the first power path is greater than or equal to the voltage threshold, the control unit turns off the fourth element part with the third element part allowing a current to flow from the power storage unit side to the second power path side.

6. The in-vehicle control device according to claim 5,
wherein if the voltage of the first power path is greater than or equal to the voltage threshold, the control unit causes the voltage conversion unit to perform the first conversion operation with the third element part allowing a current to flow from the power storage unit side to the second power path side.

7. The in-vehicle control device according to claim 1,
wherein the second element part is configured to interrupt a current flow between the first power path and the third power path through the second element part in both directions when the second element part is OFF, and to allow a current to flow from the first power path to the third power path through the second element part when the second element part is ON,
if a voltage of the first power path exceeds a first threshold and is less than a voltage threshold, which is greater than the first threshold, the control unit turns on the second element part, and
if the voltage of the first power path is greater than or equal to the voltage threshold, the control unit turns off the second element part and causes the voltage conversion unit to perform the second conversion operation with the first element part allowing a current to flow from the third power path side to the second power path side.

8. The in-vehicle control device according to claim 1,
wherein if a predetermined condition is satisfied when a voltage of the first power path is less than or equal to a first threshold, the control unit causes the voltage conversion unit to perform the first conversion operation with the third element part allowing a current to flow from the power storage unit side to the second power path side.

9. The in-vehicle control device according to claim 8,
wherein the predetermined condition includes a condition that a predetermined failure determination condition is not satisfied,
if the failure determination condition is not satisfied when the voltage of the first power path is less than or equal to the first threshold, the control unit causes the voltage conversion unit to perform the first conversion operation with the second element part allowing a current to flow from the first power path side to the voltage conversion unit side, and
if the failure determination condition is satisfied when the voltage of the first power path is less than or equal to the first threshold, the control unit causes the voltage conversion unit to perform the second conversion operation, with the second element part interrupting a current flow from the voltage conversion unit side to the first power path side and the first element part allowing a current to flow from the third power path side to the second power path side.

10. The in-vehicle control device according to claim 9,
wherein the third element part is configured to interrupt a current flow between the fourth power path and the second power path through the third element part in both directions when the third element part is OFF, and to allow a current to flow from the fourth power path to the second power path through the third element part when the third element part is ON,
the control unit controls ON/OFF of at least the third element part, and
if the voltage of the first power path is less than or equal to the first threshold and switching is made from a state where the failure determination condition is not satisfied to a state where the failure determination condition is satisfied, the control unit keeps the third element part ON before and after the switching, the control unit causes, after the switching, the voltage conversion unit to perform the second conversion operation with the second element part interrupting a current flow from the voltage conversion unit side to the first power path side and the first element part allowing a current to flow from the third power path side to the second power path side, and the control unit switches off the third element part if the voltage conversion unit satisfies a predetermined operation condition after the switching.

11. The in-vehicle control device according to claim 9,
wherein the failure determination condition includes a condition that a current flows from the voltage conversion unit side to the first power path side via the second element part,
if no current flows from the voltage conversion unit side to the first power path side via the second element part when the voltage of the first power path is less than or equal to the first threshold, the control unit causes the voltage conversion unit to perform the first conversion operation with the second element part allowing a current to flow from the first power path side to the voltage conversion unit side, and the third element part allows a current to flow from the power storage unit side to the second power path side, and
if a current flows from the voltage conversion unit side to the first power path side via the second element part when the voltage of the first power path is less than or equal to the first threshold, the control unit causes the voltage conversion unit to perform the second conversion operation, with the second element part interrupting a current flow from the voltage conversion unit side to the first power path side and the first element part allowing a current to flow from the third power path side to the second power path side.

12. The in-vehicle control device according to claim 9,
wherein the failure determination condition includes a condition that the voltage of the first power path is less than or equal to a second threshold, which is lower than the first threshold,
if the voltage of the first power path is less than or equal to the first threshold and exceeds the second threshold, the control unit causes the voltage conversion unit to perform the first conversion operation with the second element part allowing a current to flow from the first power path side to the voltage conversion unit side, and the third element part allows a current to flow from the power storage unit side to the second power path side, and
if the voltage of the first power path is less than or equal to the second threshold, the control unit causes the voltage conversion unit to perform the second conversion operation, with the second element part interrupting a current flow from the voltage conversion unit side to the first power path side and the first element part allowing a current to flow from the third power path side to the second power path side.

13. The in-vehicle control device according to claim 9,
wherein the failure determination condition includes a condition that a predetermined failure signal is given to the in-vehicle control device from an external device other than the in-vehicle control device,
if the voltage of the first power path is less than or equal to the first threshold and no failure signal is given from the external device, the control unit causes the voltage conversion unit to perform the first conversion operation with the second element part allowing a current to flow from the first power path side to the voltage conversion unit side, and the third element part allows a current to flow from the power storage unit side to the second power path side, and
if the voltage of the first power path is less than or equal to the first threshold and the failure signal is given from the external device, the control unit causes the voltage conversion unit to perform the second conversion operation, with the second element part interrupting a current flow from the voltage conversion unit side to the first power path side and the first element part allowing a current to flow from the third power path side to the second power path side.

14. The in-vehicle control device according to claim 8,
wherein during a period in which the voltage conversion unit is caused to perform the first conversion operation with the third element part allowing a current to flow from the power storage unit side to the second power path side, the control unit sets power supplied from the voltage conversion unit to the fourth power path side to be larger than power supplied to the second power path side via the third element part.

15. The in-vehicle control device according to claim 3,
wherein if the voltage of the first power path exceeds the first threshold and an output voltage of the power storage unit is less than or equal to a predetermined value, the control unit causes the voltage conversion unit to perform the first conversion operation with the second element part allowing a current to flow from the first power path side to the voltage conversion unit side.
